(19) United States
(12) Patent Application Publication
(10) Pub. No.: US 2025/0211868 A1
(43) Pub. Date: Jun. 26, 2025

(54) SENSOR DEVICE AND METHOD FOR OPERATING A SENSOR DEVICE

(71) Applicants: Sony Group Corporation, Tokyo (JP); ETH Zürich (Eidgenössische Technische Hochschule Zürich), Zürich (CH)

(72) Inventors: Valery VISHNEVSKIY, Zürich (CH); Diederik Paul MOEYS, Zürich (CH); Sebastian KOZERKE, Zürich (CH)

(73) Assignees: Sony Group Corporation, Tokyo (JP); ETH Zürich (Eidgenössische Technische Hochschule Zürich), Zürich (CH)

(21) Appl. No.: 18/850,577

(22) PCT Filed: Mar. 14, 2023
(86) PCT No.: PCT/EP2023/056477

§ 371 Date: Sep. 25, 2024

(30) Foreign Application Priority Data
Mar. 31, 2022 (EP) 22165769.5

(51) Int. Cl. H04N 25/47; H04N 25/707

(52) U.S. Cl. CPC H04N 25/47; H04N 25/707

(57) ABSTRACT

A sensor device comprises a plurality of pixels each configured to receive light and perform photoelectric conversion to generate an electrical signal, and circuitry that is configured to detect as event data intensity changes above a predetermined threshold of the light received by each of a first subset of the pixels, generate a pixel signal indicating intensity values of the received light for each pixel of a second subset of the pixels, start detection of event data at a first point in time earlier than generation of pixel signals at a second point in time, and reconstruct intensity values for the second subset of pixels for a time period between the first point in time and the second point in time by using the pixel signals generated after the second point in time and the event data detected before the second point in time.

### FIELD OF THE INVENTION

The present technology relates to a sensor device and a method for operating a sensor device, in particular, to a sensor device and a method for operating a sensor device that allow reconstruction of image frames preceding the start time of camera recording using an event-based vision sensor, EVS.

### BACKGROUND

Usual digital video cameras that are e.g. used as stand-alone devices or integrated into other electronic devices such as mobile phones include sensor devices that usually start capturing a video after an according instruction from a user, such as e.g. pressing down a button. However, when a sudden or unusual event happens, a person might want to start recording it, but by the time they trigger start of the video, they might have missed the initial part of the scene.

It is therefore desirable to improve the imaging capacities of sensor devices such as to allow reconstruction of image frames preceding the start time of the video recording.

### SUMMARY OF INVENTION

To this end, a sensor device is provided that comprises a plurality of pixels each configured to receive light and perform photoelectric conversion to generate an electrical signal, event detection circuitry that is configured to detect as event data intensity changes above a predetermined threshold of the light received by each of a first subset of the pixels, and pixel signal generating circuitry that is configured to generate a pixel signal indicating intensity values of the received light for each pixel of a second subset of the pixels. The sensor device comprises further a control unit that is configured to start detection of event data at a first point in time earlier than generation of pixel signals at a second point in time, and to reconstruct intensity values for the second subset of pixels for a time period between the first point in time and the second point in time by using the pixel signals generated after the second point in time and the event data detected before the second point in time.

Further, a method for operating a sensor device is provided, the method comprising: receiving light and performing photoelectric conversion with a plurality of pixels of the sensor device to generate an electrical signal; detecting as event data intensity changes above a predetermined threshold of the light received by each of a first subset of the pixels; generating a pixel signal indicating intensity values of the received light for each pixel of a second subset of the pixels; starting detection of event data at a first point in time earlier than generation of pixel signals at a second point in time; and reconstructing intensity values for the second subset of pixels for a time period between the first point in time and the second point in time by using the pixel signals generated after the second point in time and the event data detected before the second point in time.

Thus, the conventional video camera pixels (second subset of pixels), which generate pixel signals representing the intensity of the received light are supplemented with EVS pixels (first subset of pixels) that are sensitive to intensity changes above a certain threshold. The EVS pixels are triggered to detect events already before the full intensity signal is obtained from the camera pixels. Once the full intensity signal is recorded, it is used together with the detected event data to reconstruct intensity values for the camera pixels at time instances preceding the start of full intensity frame capturing. In this manner captured videos can be extended backwards in time. Usage of EVS pixels is particularly useful in this regard since the event detection circuitry consumes less energy than the pixel signal generation circuitry, such that the extended duration of event detection does not overly deplete an energy storage of the sensor device. Moreover, the high time resolution of the event data allows correction of motion blur that might occur right after full intensity frame capturing has been initiated.

### BRIEF DESCRIPTION OF DRAWINGS

FIG. 1 is a schematic diagram of a sensor device.

FIG. 2 is a schematic block diagram of a sensor section.

FIG. 3 is a schematic block diagram of a pixel array section.

FIG. 4 is a schematic circuit diagram of a pixel block.

FIG. 5 is a schematic block diagram illustrating of an event detecting section.

FIG. 6 is a schematic circuit diagram of a current-voltage converting section.

FIG. 7 is a schematic circuit diagram of a subtraction section and a quantization section.

FIG. 8 is a schematic timing chart of an example operation of the sensor section.

FIG. 9 is a schematic diagram of a frame data generation method based on event data.

FIG. 10 is a schematic block diagram of another quantization section.

FIG. 11 is a schematic diagram of another event detecting section.

FIG. 12 is a schematic block diagram of another pixel array section.

FIG. 13 is a schematic circuit diagram of another pixel block.

FIG. 14 is a schematic block diagram of a scan-type imaging device.

FIG. 15 is a schematic block diagram of a sensor device and its function.

FIG. 16 is a schematic illustration of frame reconstruction.

FIG. 17 is a schematic illustration of frame reconstruction according to a comparative example.

FIG. 18 is a schematic illustration of frame reconstruction.

FIG. 19 shows different schematic block diagrams of a sensor device.

FIG. 20 illustrates schematically a process flow of a method for operating a sensor device

FIG. 21 is a schematic block diagram of a smart phone.

### DETAILED DESCRIPTION

The present disclosure is directed to mitigating problems occurring during the start of video capturing. In particular, the problem is addressed how to ensure that sensor devices start operating sufficiently early to allow capturing the desired scenes without overly depleting the sensor device's energy storage. The solutions to this problem discussed below are applicable to all sensor types that allow capturing a scene by generating an event data stream together with a full intensity frame sequence. However, in order to ease the description and also in order to cover an important application example, the following description is focused without prejudice on a specific implementation of a dynamic vision sensor/event-based vision sensor (DVS/EVS).

Thus, first a possible implementation of a DVS/EVS will be described. This is of course purely exemplary. It is to be understood that DVSs/EVSs could also be implemented differently.

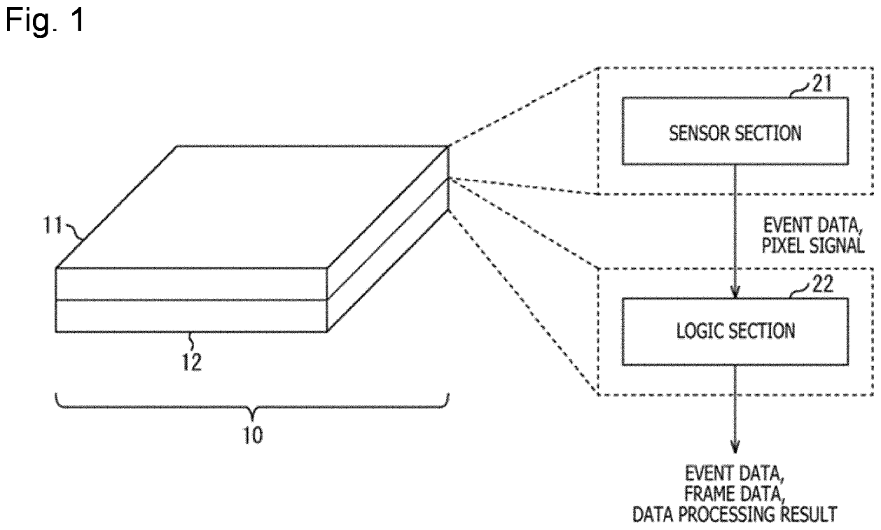

FIG. 1 is a diagram illustrating a configuration example of a sensor device 10, which is in the example of FIG. 1 constituted by a sensor chip.

The sensor device 10 is a single-chip semiconductor chip and includes a sensor die (substrate) 11, which serves as a plurality of dies (substrates), and a logic die 12 that are stacked. Note that, the sensor device 10 can also include only a single die or three or more stacked dies.

In the sensor device 10 of FIG. 1, the sensor die 11 includes (a circuit serving as) a sensor section 21, and the logic die 12 includes a logic section 22. Note that, the sensor section 21 can be partly formed on the logic die 12. Further, the logic section 22 can be partly formed on the sensor die 11.

The sensor section 21 includes pixels configured to perform photoelectric conversion on incident light to generate electrical signals, and generates event data indicating the occurrence of events that are changes in the electrical signal of the pixels. The sensor section 21 supplies the event data to the logic section 22. That is, the sensor section 21 performs imaging of performing, in the pixels, photoelectric conversion on incident light to generate electrical signals, similarly to a synchronous image sensor, for example. The sensor section 21, however, also generates event data indicating the occurrence of events that are changes in the electrical signal of the pixels in addition to generating image data in a frame format (frame data). The sensor section 21 outputs, to the logic section 22, the event data obtained by the imaging.

Here, the synchronous image sensor is an image sensor configured to perform imaging in synchronization with a vertical synchronization signal and output frame data that is image data in a frame format. The event detection functions of the sensor section 21 can be regarded as asynchronous (an asynchronous image sensor) in contrast to the synchronous image sensor, since as far as event detection is concerned the sensor section 21 does not operate in synchronization with a vertical synchronization signal when outputting event data.

Note that, the sensor section 21 generates and outputs, other than event data, frame data, similarly to the synchronous image sensor. In addition, the sensor section 21 can output, together with event data, electrical signals of pixels in which events have occurred, as pixel signals that are pixel values of the pixels in frame data.

The logic section 22 controls the sensor section 21 as needed. Further, the logic section 22 performs various types of data processing, such as data processing of generating frame data on the basis of event data from the sensor section 21 and image processing on frame data from the sensor section 21 or frame data generated on the basis of the event data from the sensor section 21, and outputs data processing results obtained by performing the various types of data processing on the event data and the frame data.

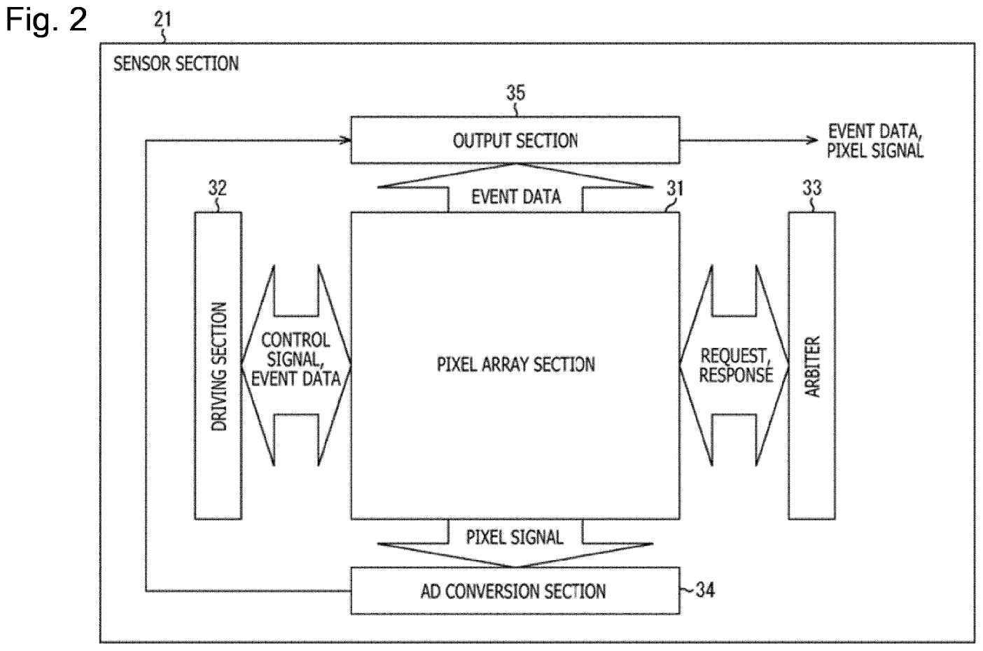

FIG. 2 is a block diagram illustrating a configuration example of the sensor section 21 of FIG. 1.

The sensor section 21 includes a pixel array section 31, a driving section 32, an arbiter 33, an AD (Analog to Digital) conversion section 34, and an output section 35.

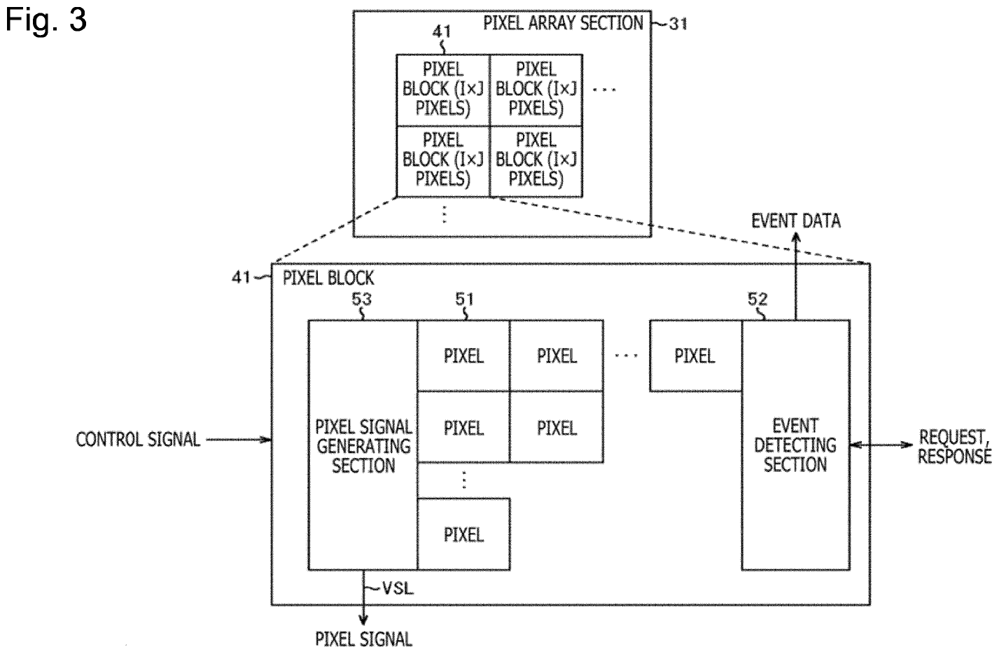

The pixel array section 31 preferably includes a plurality of pixels 51 (FIG. 3) arrayed in a two-dimensional lattice pattern. The pixel array section 31 detects, in a case where a change larger than a predetermined threshold (including a change equal to or larger than the threshold as needed) has occurred in (a voltage corresponding to) a photocurrent that is an electrical signal generated by photoelectric conversion in the pixel 51, the change in the photocurrent as an event. In a case of detecting an event, the pixel array section 31 outputs, to the arbiter 33, a request for requesting the output of event data indicating the occurrence of the event. Then, in a case of receiving a response indicating event data output permission from the arbiter 33, the pixel array section 31 outputs the event data to the driving section 32 and the output section 35. In addition, the pixel array section 31 may output an electrical signal of the pixel 51 in which the event has been detected to the AD conversion section 34, as a pixel signal.

The driving section 32 supplies control signals to the pixel array section 31 to drive the pixel array section 31. For example, the driving section 32 drives the pixel 51 regarding which the pixel array section 31 has output event data, so that the pixel 51 in question supplies (outputs) a pixel signal to the AD conversion section 34. But the driving section 32 may also drive the pixels 51 in a synchronous manner to generate frame data.

The arbiter 33 arbitrates the requests for requesting the output of event data from the pixel array section 31, and returns responses indicating event data output permission or prohibition to the pixel army section 31.

The AD conversion section 34 includes, for example, a single-slope ADC (AD converter) (not illustrated) in each column of pixel blocks 41 (FIG. 3) described later, for example. The AD conversion section 34 performs, with the ADC in each column, AD conversion on pixel signals of the pixels 51 of the pixel blocks 41 in the column, and supplies the resultant to the output section 35. Note that, the AD conversion section 34 can perform CDS (Correlated Double Sampling) together with pixel signal AD conversion.

The output section 35 performs necessary processing on the pixel signals from the AD conversion section 34 and the event data from the pixel array section 31 and supplies the resultant to the logic section 22 (FIG. 1).

Here, a change in the photocurrent generated in the pixel 51 can be recognized as a change in the amount of light entering the pixel 51, so that it can also be said that an event is a change in light amount (a change in light amount larger than the threshold) in the pixel 51.

Event data indicating the occurrence of an event at least includes location information (coordinates or the like) indicating the location of a pixel block in which a change in light amount, which is the event, has occurred. Besides, the event data can also include the polarity (positive or negative) of the change in light amount.

With regard to the series of event data that is output from the pixel array section 31 at timings at which events have occurred, it can be said that, as long as the event data interval is the same as the event occurrence interval, the event data implicitly includes time point information indicating (relative) time points at which the events have occurred. However, for example, when the event data is stored in a memory and the event data interval is no longer the same as the event occurrence interval, the time point information implicitly included in the event data is lost. Thus, the output section 35 includes, in event data, time point information indicating (relative) time points at which events have occurred, such as timestamps, before the event data interval is changed from the event occurrence interval. The processing of including time point information in event data can be performed in any block other than the output section 35 as long as the processing is performed before time point information implicitly included in event data is lost.

FIG. 3 is a block diagram illustrating a configuration example of the pixel array section 31 of FIG. 2.

The pixel array section 31 may include a plurality of pixel blocks 41. Each pixel block 41 may include the I×J pixels 51 that are one or more pixels arrayed in I rows and J columns (I and J are integers), an event detecting section 52, and a pixel signal generating section 53. The one or more pixels 51 in the pixel block 41 share the event detecting section 52 and the pixel signal generating section 53. Further, in each column of the pixel blocks 41, a VSL (Vertical Signal Line) for connecting the pixel blocks 41 to the ADC of the AD conversion section 34 is wired.

The pixel 51 receives light incident from an object and performs photoelectric conversion to generate a photocurrent serving as an electrical signal. The pixel 51 supplies the photocurrent to the event detecting section 52 under the control of the driving section 32.

The event detecting section 52 detects, as an event, a change larger than the predetermined threshold in photocurrent from each of the pixels 51, under the control of the driving section 32. In a case of detecting an event, the event detecting section 52 may supply, to the arbiter 33 (FIG. 2), a request for requesting the output of event data indicating the occurrence of the event. Then, when receiving a response indicating event data output permission to the request from the arbiter 33, the event detecting section 52 outputs the event data to the driving section 32 and the output section 35.

The pixel signal generating section 53 generates, in the case where the event detecting section 52 has detected an event, a voltage corresponding to a photocurrent from the pixel 51 as a pixel signal, and supplies the voltage to the AD conversion section 34 through the VSL, under the control of the driving section 32.

Here, detecting a change larger than the predetermined threshold in photocurrent as an event can also be recognized as detecting, as an event, absence of change larger than the predetermined threshold in photocurrent. The pixel signal generating section 53 can generate a pixel signal in the case where absence of change larger than the predetermined threshold in photocurrent has been detected as an event as well as in the case where a change larger than the predetermined threshold in photocurrent has been detected as an event.

Further, the event detecting section 52 and the pixel signal generating section 53 may operate independently from each other. This means that while event data are generated by the event detecting section 52, pixel signals are generated by the pixel signal generating section 53 in a synchronous manner to generate frame data. The event detecting section 52 and the pixel signal generating section 53 may also operate in a time multiplexed manner such that each of the sections receives the photocurrent from the pixels 51 only during different time intervals.

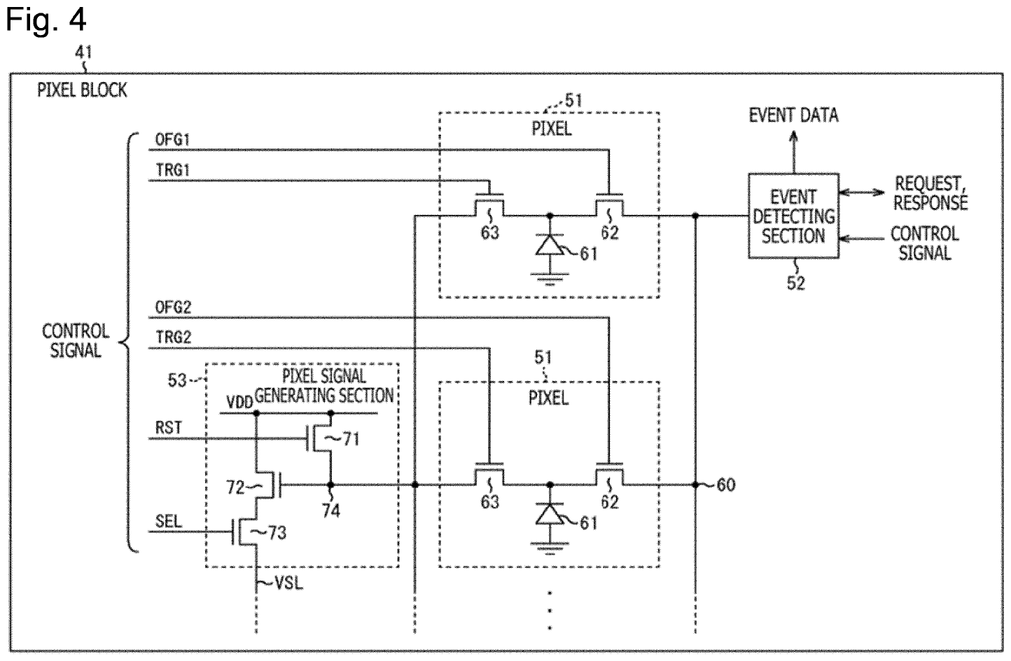

FIG. 4 is a circuit diagram illustrating a configuration example of the pixel block 41. The configuration of FIG. 4 may be referred to as “shared pixel configuration”.

The pixel block 41 includes, as described with reference to FIG. 3, the pixels 51, the event detecting section 52, and the pixel signal generating section 53.

The pixel 51 includes a photoelectric conversion element 61 and transfer transistors 62 and 63.

The photoelectric conversion element 61 includes, for example, a PD (Photodiode). The photoelectric conversion element 61 receives incident light and performs photoelectric conversion to generate charges.

The transfer transistor 62 includes, for example, an N (Negative)-type MOS (Metal-Oxide-Semiconductor) FET (Field Effect Transistor). The transfer transistor 62 of the n-th pixel 51 of the I×J pixels 51 in the pixel block 41 is turned on or off in response to a control signal OFGn supplied from the driving section 32 (FIG. 2). When the transfer transistor 62 is turned on, charges generated in the photoelectric conversion element 61 are transferred (supplied) to the event detecting section 52, as a photocurrent.

The transfer transistor 63 includes, for example, an N-type MOSFET. The transfer transistor 63 of the n-th pixel 51 of the I×J pixels 51 in the pixel block 41 is turned on or off in response to a control signal TRGn supplied from the driving section 32. When the transfer transistor 63 is turned on, charges generated in the photoelectric conversion element 61 are transferred to an FD 74 of the pixel signal generating section 53.

The I×J pixels 51 in the pixel block 41 are connected to the event detecting section 52 of the pixel block 41 through nodes 60. Thus, photocurrents generated in (the photoelectric conversion elements 61 of) the pixels 51 are supplied to the event detecting section 52 through the nodes 60. As a result, the event detecting section 52 receives the sum of photocurrents from all the pixels 51 in the pixel block 41. Thus, the event detecting section 52 detects, as an event, a change in sum of photocurrents supplied from the I×J pixels 51 in the pixel block 41.

The pixel signal generating section 53 includes a reset transistor 71, an amplification transistor 72, a selection transistor 73, and the FD (Floating Diffusion) 74.

The reset transistor 71, the amplification transistor 72, and the selection transistor 73 include, for example, N-type MOSFETs.

The reset transistor 71 is turned on or off in response to a control signal RST supplied from the driving section 32 (FIG. 2). When the reset transistor 71 is turned on, the FD 74 is connected to a power supply VDD, and charges accumulated in the FD 74 are thus discharged to the power supply VDD. With this, the FD 74 is reset.

The amplification transistor 72 has a gate connected to the FD 74, a drain connected to the power supply VDD, and a source connected to the VSL through the selection transistor 73. The amplification transistor 72 is a source follower and outputs a voltage (electrical signal) corresponding to the voltage of the FD 74 supplied to the gate to the VSL through the selection transistor 73.

The selection transistor 73 is turned on or off in response to a control signal SEL supplied from the driving section 32. When the selection transistor 73 is turned on, a voltage corresponding to the voltage of the FD 74 from the amplification transistor 72 is output to the VSL.

The FD 74 accumulates charges transferred from the photoelectric conversion elements 61 of the pixels 51 through the transfer transistors 63, and converts the charges to voltages.

With regard to the pixels 51 and the pixel signal generating section 53, which are configured as described above, the driving section 32 turns on the transfer transistors 62 with control signals OFGn, so that the transfer transistors 62 supply, to the event detecting section 52, photocurrents based on charges generated in the photoelectric conversion elements 61 of the pixels 51. With this, the event detecting section 52 receives a current that is the sum of the photocurrents from all the pixels 51 in the pixel block 41, which might also be only a single pixel.

When the event detecting section 52 detects, as an event, a change in photocurrent (sum of photocurrents) in the pixel block 41, the driving section 32 may turn off the transfer transistors 62 of all the pixels 51 in the pixel block 41, to thereby stop the supply of the photocurrents to the event detecting section 52. Then, the driving section 32 may sequentially turn on, with the control signals TRGn, the transfer transistors 63 of the pixels 51 in the pixel block 41 in which the event has been detected, so that the transfer transistors 63 transfers charges generated in the photoelectric conversion elements 61 to the FD 74. The FD 74 accumulates the charges transferred from (the photoelectric conversion elements 61 of) the pixels 51. Voltages corresponding to the charges accumulated in the FD 74 are output to the VSL, as pixel signals of the pixels 51, through the amplification transistor 72 and the selection transistor 73.

As described above, in the sensor section 21 (FIG. 2), in this manner only pixel signals of the pixels 51 in the pixel block 41 in which an event has been detected are sequentially output to the VSL. The pixel signals output to the VSL are supplied to the AD conversion section 34 to be subjected to AD conversion.

Here, in the pixels 51 in the pixel block 41, the transfer transistors 63 can be turned on not sequentially but simultaneously. In this case, the sum of pixel signals of all the pixels 51 in the pixel block 41 can be output.

Further, it is also possible to operate the pixel generating section 53 independently from the event detection by controlling the transfer transistors 63 without regard of the event detection or by entirely omitting the transfer transistors 63. In this case frame data can be generated by the pixel generating section 53 in the conventional, synchronous manner, while the event detection can be performed concurrently. If necessary, photocurrent transfer to the event detecting section 52 and the pixel signal generating section 53 may be time multiplexed such that only one of the two transfer transistors 62, 63 per pixel 51 is open at a given point in time.

In the pixel array section 31 of FIG. 3, the pixel block 41 includes one or more pixels 51, and the one or more pixels 51 share the event detecting section 52 and the pixel signal generating section 53. Thus, in the case where the pixel block 41 includes a plurality of pixels 51, the numbers of the event detecting sections 52 and the pixel signal generating sections 53 can be reduced as compared to a case where the event detecting section 52 and the pixel signal generating section 53 are provided for each of the pixels 51, with the result that the scale of the pixel array section 31 can be reduced.

Note that, in the case where the pixel block 41 includes a plurality of pixels 51, the event detecting section 52 can be provided for each of the pixels 51. In the case where the plurality of pixels 51 in the pixel block 41 share the event detecting section 52, events are detected in units of the pixel blocks 41. In the case where the event detecting section 52 is provided for each of the pixels 51, however, events can be detected in units of the pixels 51.

Yet, even in the case where the plurality of pixels 51 in the pixel block 41 share the single event detecting section 52, events can be detected in units of the pixels 51 when the transfer transistors 62 of the plurality of pixels 51 are temporarily turned on in a time-division manner.

Further, in a case where there is no need to output pixel signals, the pixel block 41 can be formed without the pixel signal generating section 53. In the case where the pixel block 41 is formed without the pixel signal generating section 53, the sensor section 21 can be formed without the AD conversion section 34 and the transfer transistors 63. In this case, the scale of the sensor section 21 can be reduced. The sensor will then output the address of the pixel (block) in which the event occurred, if necessary with a time stamp.

Moreover, additional pixels 51 connected to pixel signal generating sections 53, but not to event detecting sections 52 may be provided on the sensor die 11. These pixels 51 may be interleaved with the pixels 51 connected to the event detecting section 52, but may also form a separate pixel array for generating frame data. The separation of the event detection function and the pixel signal generating function may even by implemented as two pixel arrays on different dies that are arranged such as to observe the same scene. Thus basically any pixel arrangement/pixel circuitry might be used that allows obtaining event data with a first subset of pixels 51 and generating of pixel signals with a second subset of pixels 51.

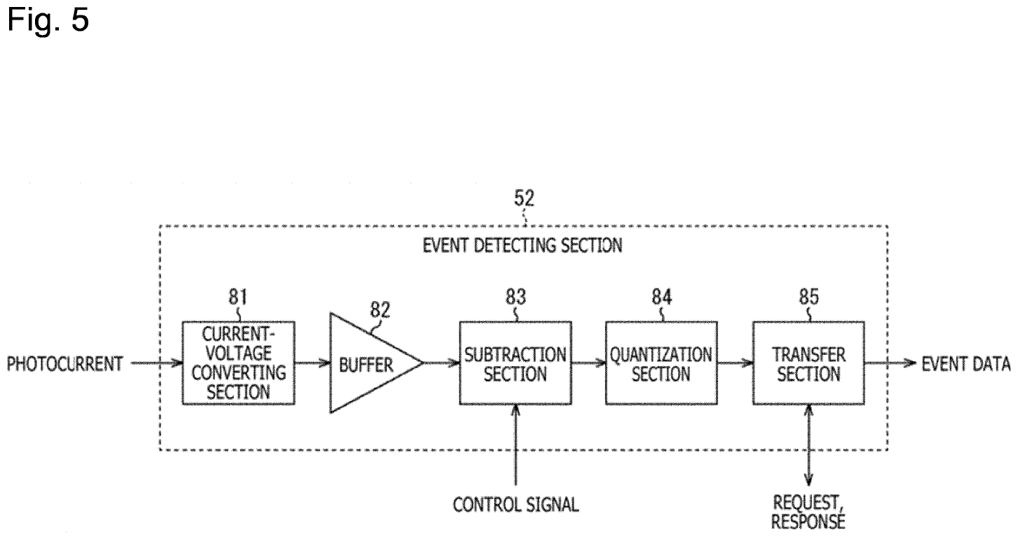

FIG. 5 is a block diagram illustrating a configuration example of the event detecting section 52 of FIG. 3.

The event detecting section 52 includes a current-voltage converting section 81, a buffer 82, a subtraction section 83, a quantization section 84, and a transfer section 85.

The current-voltage converting section 81 converts (a sum of) photocurrents from the pixels 51 to voltages corresponding to the logarithms of the photocurrents (hereinafter also referred to as a “photovoltage”) and supplies the voltages to the buffer 82.

The buffer 82 buffers photovoltages from the current-voltage converting section 81 and supplies the resultant to the subtraction section 83.

The subtraction section 83 calculates, at a timing instructed by a row driving signal that is a control signal from the driving section 32, a difference between the current photovoltage and a photovoltage at a timing slightly shifted from the current time, and supplies a difference signal corresponding to the difference to the quantization section 84.

The quantization section 84 quantizes difference signals from the subtraction section 83 to digital signals and supplies the quantized values of the difference signals to the transfer section 85 as event data.

The transfer section 85 transfers (outputs), on the basis of event data from the quantization section 84, the event data to the output section 35. That is, the transfer section 85 supplies a request for requesting the output of the event data to the arbiter 33. Then, when receiving a response indicating event data output permission to the request from the arbiter 33, the transfer section 85 outputs the event data to the output section 35.

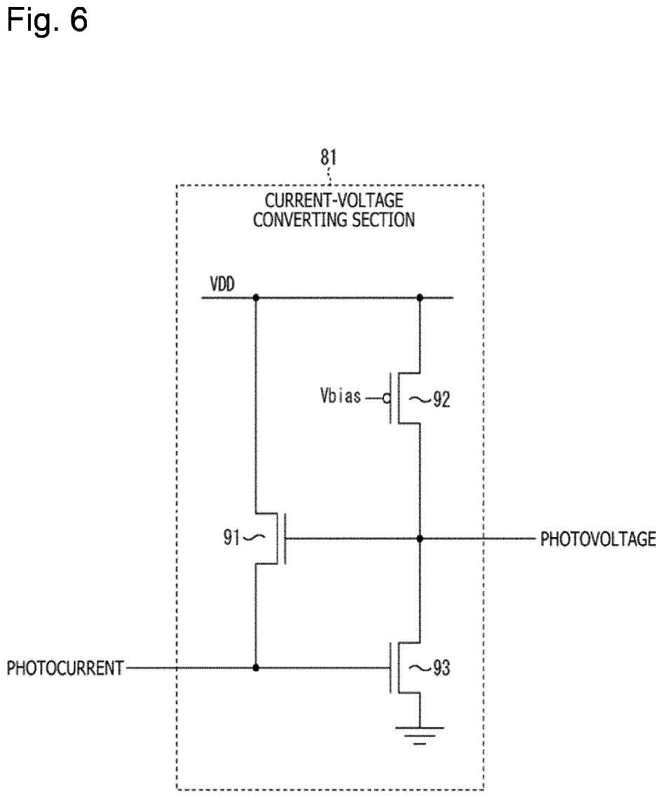

FIG. 6 is a circuit diagram illustrating a configuration example of the current-voltage converting section 81 of FIG. 5.

The current-voltage converting section 81 includes transistors 91 to 93. As the transistors 91 and 93, for example, N-type MOSFETs can be employed. As the transistor 92, for example, a P-type MOSFET can be employed.

The transistor 91 has a source connected to the gate of the transistor 93, and a photocurrent is supplied from the pixel 51 to the connecting point between the source of the transistor 91 and the gate of the transistor 93. The transistor 91 has a drain connected to the power supply VDD and a gate connected to the drain of the transistor 93.

The transistor 92 has a source connected to the power supply VDD and a drain connected to the connecting point between the gate of the transistor 91 and the drain of the transistor 93. A predetermined bias voltage Vbias is applied to the gate of the transistor 92. With the bias voltage Vbias, the transistor 92 is turned on or off, and the operation of the current-voltage converting section 81 is turned on or off depending on whether the transistor 92 is turned on or off.

The source of the transistor 93 is grounded.

In the current-voltage converting section 81, the transistor 91 has the drain connected on the power supply VDD side and is thus a source follower. The source of the transistor 91, which is the source follower, is connected to the pixels 51 (FIG. 4), so that photocurrents based on charges generated in the photoelectric conversion elements 61 of the pixels 51 flow through the transistor 91 (from the drain to the source). The transistor 91 operates in a subthreshold region, and at the gate of the transistor 91, photovoltages corresponding to the logarithms of the photocurrents flowing through the transistor 91 are generated. As described above, in the current-voltage converting section 81, the transistor 91 converts photocurrents from the pixels 51 to photovoltages corresponding to the logarithms of the photocurrents.

In the current-voltage converting section 81, the transistor 91 has the gate connected to the connecting point between the drain of the transistor 92 and the drain of the transistor 93, and the photovoltages are output from the connecting point in question.

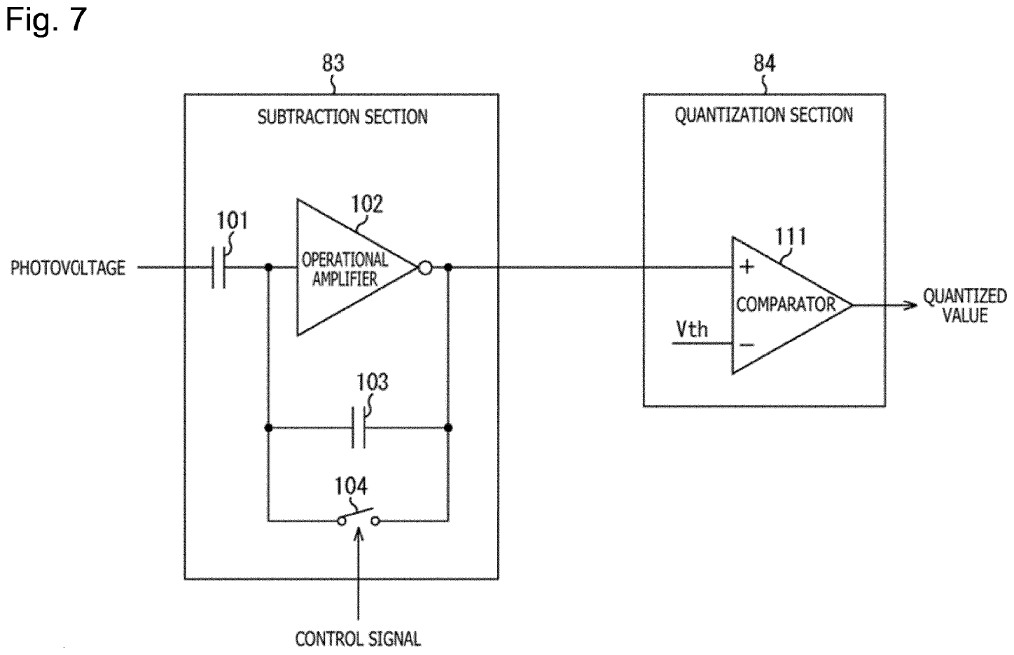

FIG. 7 is a circuit diagram illustrating configuration examples of the subtraction section 83 and the quantization section 84 of FIG. 5.

The subtraction section 83 includes a capacitor 101, an operational amplifier 102, a capacitor 103, and a switch 104. The quantization section 84 includes a comparator 111.

The capacitor 101 has one end connected to the output terminal of the buffer 82 (FIG. 5) and the other end connected to the input terminal (inverting input terminal) of the operational amplifier 102. Thus, photovoltages are input to the input terminal of the operational amplifier 102 through the capacitor 101.

The operational amplifier 102 has an output terminal connected to the non-inverting input terminal (+) of the comparator 111.

The capacitor 103 has one end connected to the input terminal of the operational amplifier 102 and the other end connected to the output terminal of the operational amplifier 102.

The switch 104 is connected to the capacitor 103 to switch the connections between the ends of the capacitor 103. The switch 104 is turned on or off in response to a row driving signal that is a control signal from the driving section 32, to thereby switch the connections between the ends of the capacitor 103.

A photovoltage on the buffer 82 (FIG. 5) side of the capacitor 101 when the switch 104 is on is denoted by Vinit, and the capacitance (electrostatic capacitance) of the capacitor 101 is denoted by C1. The input terminal of the operational amplifier 102 serves as a virtual ground terminal, and a charge Qinit that is accumulated in the capacitor 101 in the case where the switch 104 is on is expressed by Expression (1).

$$Qinit = C 1 \times Vinit \qquad ( 1 )$$

Further, in the case where the switch 104 is on, the connection between the ends of the capacitor 103 is cut (short-circuited), so that no charge is accumulated in the capacitor 103.

When a photovoltage on the buffer 82 (FIG. 5) side of the capacitor 101 in the case where the switch 104 has thereafter been turned off is denoted by Vafter, a charge Qafter that is accumulated in the capacitor 101 in the case where the switch 104 is off is expressed by Expression (2).

$$Qafter = C 1 \times Vafter \qquad ( 2 )$$

When the capacitance of the capacitor 103 is denoted by C2 and the output voltage of the operational amplifier 102 is denoted by Vout, a charge Q2 that is accumulated in the capacitor 103 is expressed by Expression (3).

$$Q 2 = - C 2 \times Vout \qquad ( 3 )$$

Since the total amount of charges in the capacitors 101 and 103 does not change before and after the switch 104 is turned off, Expression (4) is established.

$$Qinit = Qafter + Q 2 \qquad ( 4 )$$

When Expression (1) to Expression (3) are substituted for Expression (4), Expression (5) is obtained.

$$Vout = - ( C 1 / C 2 ) \times ( Vafter - Vinit ) \qquad ( 5 )$$

With Expression (5), the subtraction section 83 subtracts the photovoltage Vinit from the photovoltage Vafter, that is, calculates the difference signal (Vout) corresponding to a difference Vafter−Vinit between the photovoltages Vafter and Vinit. With Expression (5), the subtraction gain of the subtraction section 83 is C1/C2. Since the maximum gain is normally desired, C1 is preferably set to a large value and C2 is preferably set to a small value. Meanwhile, when C2 is too small, kTC noise increases, resulting in a risk of deteriorated noise characteristics. Thus, the capacitance C2 can only be reduced in a range that achieves acceptable noise. Further, since the pixel blocks 41 each have installed therein the event detecting section 52 including the subtraction section 83, the capacitances C1 and C2 have space constraints. In consideration of these matters, the values of the capacitances C1 and C2 are determined.

The comparator 111 compares a difference signal from the subtraction section 83 with a predetermined threshold (voltage) Vth (>0) applied to the inverting input terminal (−), thereby quantizing the difference signal. The comparator 111 outputs the quantized value obtained by the quantization to the transfer section 85 as event data.

For example, in a case where a difference signal is larger than the threshold Vth, the comparator 111 outputs an H (High) level indicating 1, as event data indicating the occurrence of an event. In a case where a difference signal is not larger than the threshold Vth, the comparator 111 outputs an L (Low) level indicating 0, as event data indicating that no event has occurred.

The transfer section 85 supplies a request to the arbiter 33 in a case where it is confirmed on the basis of event data from the quantization section 84 that a change in light amount that is an event has occurred, that is, in the case where the difference signal (Vout) is larger than the threshold Vth. When receiving a response indicating event data output permission, the transfer section 85 outputs the event data indicating the occurrence of the event (for example, H level) to the output section 35.

The output section 35 includes, in event data from the transfer section 85, location/address information regarding (the pixel block 41 including) the pixel 51 in which an event indicated by the event data has occurred and time point information indicating a time point at which the event has occurred, and further, as needed, the polarity of a change in light amount that is the event, i.e. whether the intensity did increase or decrease. The output section 35 outputs the event data.

As the data format of event data including location information regarding the pixel 51 in which an event has occurred, time point information indicating a time point at which the event has occurred, and the polarity of a change in light amount that is the event, for example, the data format called “AER (Address Event Representation)” can be employed.

Note that, a gain A of the entire event detecting section 52 is expressed by the following expression where the gain of the current-voltage converting section 81 is denoted by CG_{log} and the gain of the buffer 82 is 1.

$$A = {CG}_{log} C 1 / C 2 ( Σ {i}_{photo} \_n ) \qquad ( 6 )$$

Here, iₚₕₒₜₒ_n denotes a photocurrent of the n-th pixel 51 of the I×J pixels 51 in the pixel block 41. In Expression (6), Σ denotes the summation of n that takes integers ranging from I to I×J.

Note that, the pixel 51 can receive any light as incident light with an optical filter through which predetermined light passes, such as a color filter. For example, in a case where the pixel 51 receives visible light as incident light, event data indicates the occurrence of changes in pixel value in images including visible objects. Further, for example, in a case where the pixel 51 receives, as incident light, infrared light, millimeter waves, or the like for ranging, event data indicates the occurrence of changes in distances to objects. In addition, for example, in a case where the pixel 51 receives infrared light for temperature measurement, as incident light, event data indicates the occurrence of changes in temperature of objects. In the present embodiment, the pixel 51 is assumed to receive visible light as incident light.

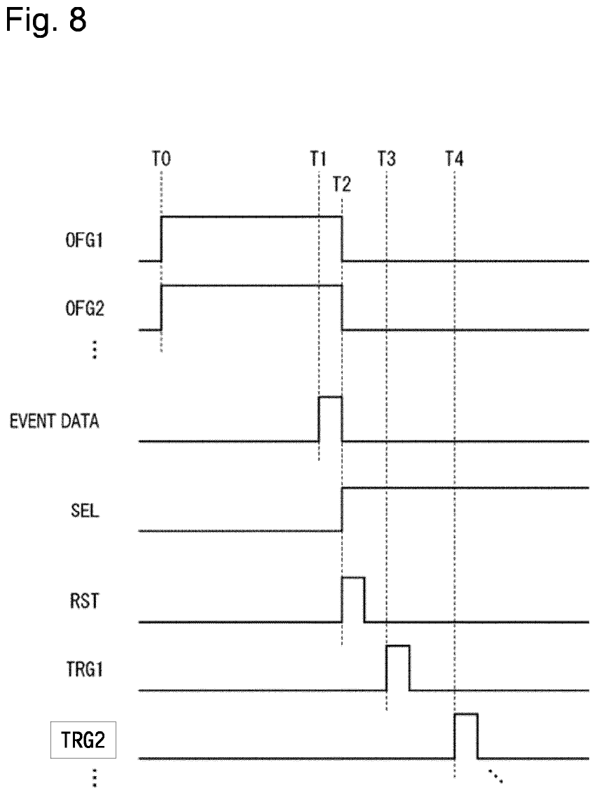

FIG. 8 is a timing chart illustrating an example of the operation of the sensor section 21 of FIG. 2.

At Timing T0, the driving section 32 changes all the control signals OFGn from the L level to the H level, thereby turning on the transfer transistors 62 of all the pixels 51 in the pixel block 41. With this, the sum of photocurrents from all the pixels 51 in the pixel block 41 is supplied to the event detecting section 52. Here, the control signals TRGn are all at the L level, and hence the transfer transistors 63 of all the pixels 51 are off.

For example, at Timing T1, when detecting an event, the event detecting section 52 outputs event data at the H level in response to the detection of the event.

At Timing T2, the driving section 32 sets all the control signals OFGn to the L level on the basis of the event data at the H level, to stop the supply of the photocurrents from the pixels 51 to the event detecting section 52. Further, the driving section 32 sets the control signal SEL to the H level, and sets the control signal RST to the H level over a certain period of time, to control the FD 74 to discharge the charges to the power supply VDD, thereby resetting the FD 74. The pixel signal generating section 53 outputs, as a reset level, a pixel signal corresponding to the voltage of the FD 74 when the FD 74 has been reset, and the AD conversion section 34 performs AD conversion on the reset level.

At Timing T3 after the reset level AD conversion, the driving section 32 sets a control signal TRG1 to the H level over a certain period to control the first pixel 51 in the pixel block 41 in which the event has been detected (or which is triggered for other reasons, as e.g. time multiplexed output and/or synchronous readout of frame data) to transfer, to the FD 74, charges generated by photoelectric conversion in (the photoelectric conversion element 61 of) the first pixel 51. The pixel signal generating section 53 outputs, as a signal level, a pixel signal corresponding to the voltage of the FD 74 to which the charges have been transferred from the pixel 51, and the AD conversion section 34 performs AD conversion on the signal level.

The AD conversion section 34 outputs, to the output section 35, a difference between the signal level and the reset level obtained after the AD conversion, as a pixel signal serving as a pixel value of the image (frame data).

Here, the processing of obtaining a difference between a signal level and a reset level as a pixel signal serving as a pixel value of an image is called “CDS.” CDS can be performed after the AD conversion of a signal level and a reset level, or can be simultaneously performed with the AD conversion of a signal level and a reset level in a case where the AD conversion section 34 performs single-slope AD conversion. In the latter case, AD conversion is performed on the signal level by using the AD conversion result of the reset level as an initial value.

At Timing T4 after the AD conversion of the pixel signal of the first pixel 51 in the pixel block 41, the driving section 32 sets a control signal TRG2 to the H level over a certain period of time to control the second pixel 51 in the pixel block 41 in which the event has been detected to output a pixel signal.

In the sensor section 21, similar processing is executed thereafter, so that pixel signals of the pixels 51 in the pixel block 41 in which the event has been detected are sequentially output.

When the pixel signals of all the pixels 51 in the pixel block 41 are output, the driving section 32 sets all the control signals OFGn to the H level to turn on the transfer transistors 62 of all the pixels 51 in the pixel block 41.

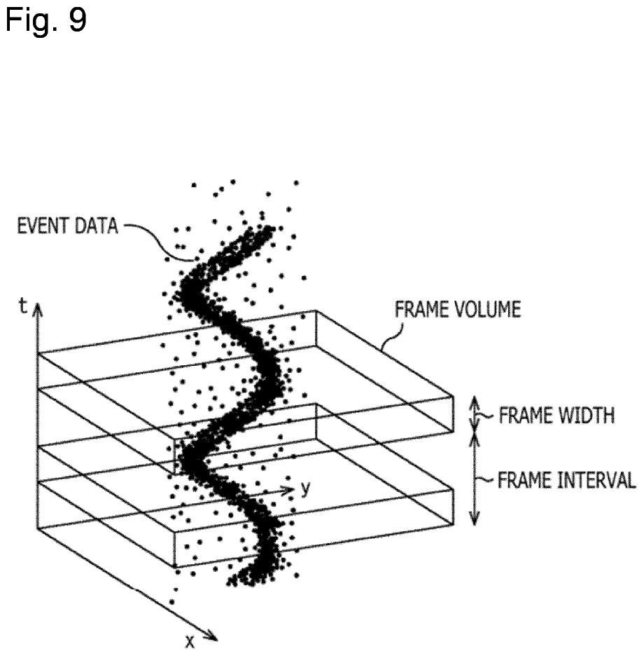

FIG. 9 is a diagram illustrating an example of a frame data generation method based on event data.

The logic section 22 sets a frame interval and a frame width on the basis of an externally input command, for example. Here, the frame interval represents the interval of frames of frame data that is generated on the basis of event data. The frame width represents the time width of event data that is used for generating frame data on a single frame. A frame interval and a frame width that are set by the logic section 22 are also referred to as a “set frame interval” and a “set frame width,” respectively.

The logic section 22 generates, on the basis of the set frame interval, the set frame width, and event data from the sensor section 21, frame data that is image data in a frame format, to thereby convert the event data to the frame data.

That is, the logic section 22 generates, in each set frame interval, frame data on the basis of event data in the set frame width from the beginning of the set frame interval.

Here, it is assumed that event data includes time point information tᵢ indicating a time point at which an event has occurred (hereinafter also referred to as an “event time point”) and coordinates (x, y) serving as location information regarding (the pixel block 41 including) the pixel 51 in which the event has occurred (hereinafter also referred to as an “event location”).

In FIG. 9, in a three-dimensional space (time and space) with the x axis, the y axis, and the time axis t, points representing event data are plotted on the basis of the event time point t and the event location (coordinates) (x, y) included in the event data.

That is, when a location (x, y, t) on the three-dimensional space indicated by the event time point t and the event location (x, y) included in event data is regarded as the space-time location of an event, in FIG. 9, the points representing the event data are plotted on the space-time locations (x, y, t) of the events.

The logic section 22 starts to generate frame data on the basis of event data by using, as a generation start time point at which frame data generation starts, a predetermined time point, for example, a time point at which frame data generation is externally instructed or a time point at which the sensor device 10 is powered on.

Here, cuboids each having the set frame width in the direction of the time axis t in the set frame intervals, which appear from the generation start time point, are referred to as a “frame volume.” The size of the frame volume in the x-axis direction or the y-axis direction is equal to the number of the pixel blocks 41 or the pixels 51 in the x-axis direction or the y-axis direction, for example.

The logic section 22 generates, in each set frame interval, frame data on a single frame on the basis of event data in the frame volume having the set frame width from the beginning of the set frame interval.

Frame data can be generated by, for example, setting white to a pixel (pixel value) in a frame at the event location (x, y) included in event data and setting a predetermined color such as gray to pixels at other locations in the frame.

Besides, in a case where event data includes the polarity of a change in light amount that is an event, frame data can be generated in consideration of the polarity included in the event data. For example, white can be set to pixels in the case a positive polarity, while black can be set to pixels in the case of a negative polarity.

In addition, in the case where pixel signals of the pixels 51 are also output when event data is output as described with reference to FIG. 3 and FIG. 4, frame data can be generated on the basis of the event data by using the pixel signals of the pixels 51. That is, frame data can be generated by setting, in a frame, a pixel at the event location (x, y) (in a block corresponding to the pixel block 41) included in event data to a pixel signal of the pixel 51 at the location (x, y) and setting a predetermined color such as gray to pixels at other locations.

Note that, in the frame volume, there are a plurality of pieces of event data that are different in the event time point t but the same in the event location (x, y) in some cases. In this case, for example, event data at the latest or oldest event time point t can be prioritized. Further, in the case where event data includes polarities, the polarities of a plurality of pieces of event data that are different in the event time point t but the same in the event location (x, y) can be added together, and a pixel value based on the added value obtained by the addition can be set to a pixel at the event location (x, y).

Here, in a case where the frame width and the frame interval are the same, the frame volumes are adjacent to each other without any gap. Further, in a case where the frame interval is larger than the frame width, the frame volumes are arranged with gaps. In a case where the frame width is larger than the frame interval, the frame volumes are arranged to be partly overlapped with each other.

As explained above, the pixel signal generating section 53 may also generate frame data in the conventional, synchronous manner.

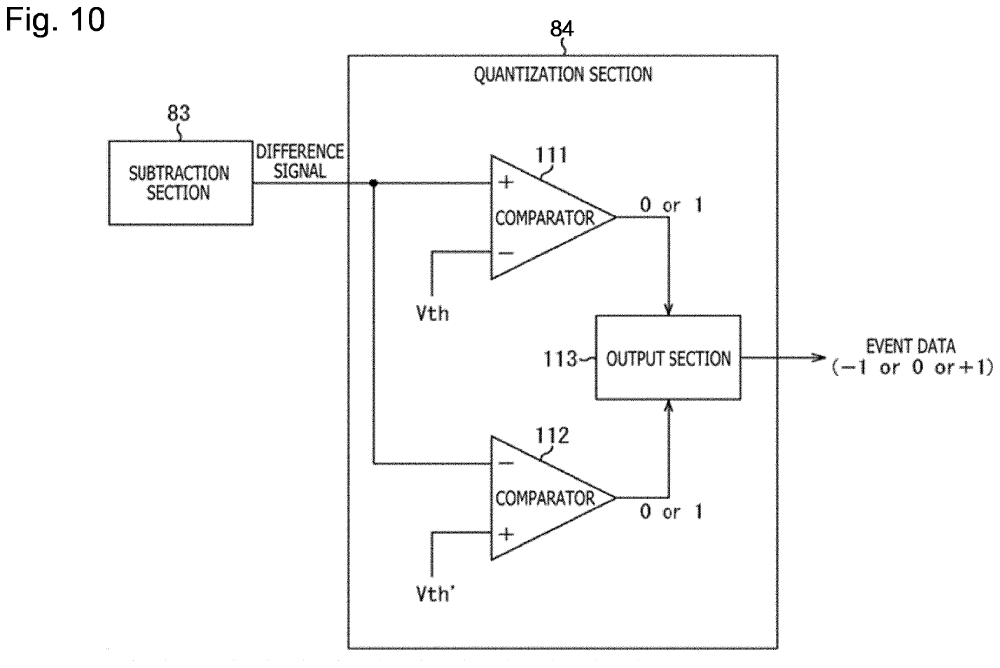

FIG. 10 is a block diagram illustrating another configuration example of the quantization section 84 of FIG. 5.

Note that, in FIG. 10, parts corresponding to those in the case of FIG. 7 are denoted by the same reference signs, and the description thereof is omitted as appropriate below.

In FIG. 10, the quantization section 84 includes comparators 111 and 112 and an output section 113.

Thus, the quantization section 84 of FIG. 10 is similar to the case of FIG. 7 in including the comparator 111. However, the quantization section 84 of FIG. 10 is different from the case of FIG. 7 in newly including the comparator 112 and the output section 113.

The event detecting section 52 (FIG. 5) including the quantization section 84 of FIG. 10 detects, in addition to events, the polarities of changes in light amount that are events.

In the quantization section 84 of FIG. 10, the comparator 111 outputs, in the case where a difference signal is larger than the threshold Vth, the H level indicating 1, as event data indicating the occurrence of an event having the positive polarity. The comparator 111 outputs, in the case where a difference signal is not larger than the threshold Vth, the L level indicating 0, as event data indicating that no event having the positive polarity has occurred.

Further, in the quantization section 84 of FIG. 10, a threshold Vth′ (<Vth) is supplied to the non-inverting input terminal (+) of the comparator 112, and difference signals are supplied to the inverting input terminal (−) of the comparator 112 from the subtraction section 83. Here, for the sake of simple description, it is assumed that the threshold Vth′ is equal to −Vth, for example, which needs however not to be the case.

The comparator 112 compares a difference signal from the subtraction section 83 with the threshold Vth′ applied to the inverting input terminal (−), thereby quantizing the difference signal. The comparator 112 outputs, as event data, the quantized value obtained by the quantization.

For example, in a case where a difference signal is smaller than the threshold Vth′ (the absolute value of the difference signal having a negative value is larger than the threshold Vth), the comparator 112 outputs the H level indicating 1, as event data indicating the occurrence of an event having the negative polarity. Further, in a case where a difference signal is not smaller than the threshold Vth′ (the absolute value of the difference signal having a negative value is not larger than the threshold Vth), the comparator 112 outputs the L level indicating 0, as event data indicating that no event having the negative polarity has occurred.

The output section 113 outputs, on the basis of event data output from the comparators 111 and 112, event data indicating the occurrence of an event having the positive polarity, event data indicating the occurrence of an event having the negative polarity, or event data indicating that no event has occurred to the transfer section 85.

For example, the output section 113 outputs, in a case where event data from the comparator 111 is the H level indicating 1, +V volts indicating +1, as event data indicating the occurrence of an event having the positive polarity, to the transfer section 85. Further, the output section 113 outputs, in a case where event data from the comparator 112 is the H level indicating 1, −V volts indicating −1, as event data indicating the occurrence of an event having the negative polarity, to the transfer section 85. In addition, the output section 113 outputs, in a case where each event data from the comparators 111 and 112 is the L level indicating 0, 0 volts (GND level) indicating 0, as event data indicating that no event has occurred, to the transfer section 85.

The transfer section 85 supplies a request to the arbiter 33 in the case where it is confirmed on the basis of event data from the output section 113 of the quantization section 84 that a change in light amount that is an event having the positive polarity or the negative polarity has occurred. After receiving a response indicating event data output permission, the transfer section 85 outputs event data indicating the occurrence of the event having the positive polarity or the negative polarity (+V volts indicating 1 or −V volts indicating −1) to the output section 35.

Preferably, the quantization section 84 has a configuration as illustrated in FIG. 10.

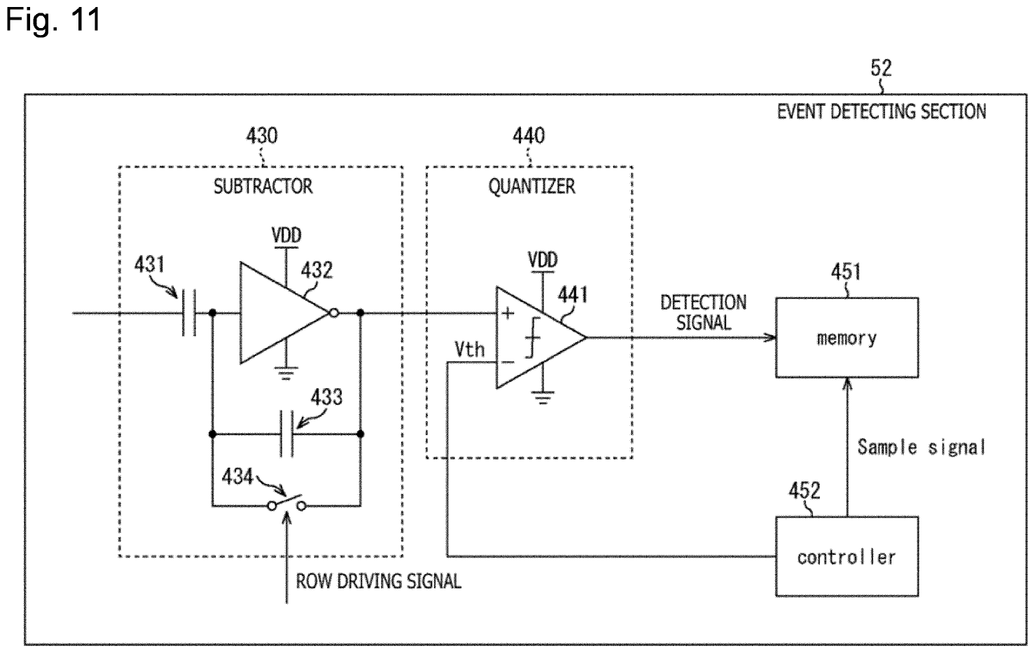

FIG. 11 is a diagram illustrating another configuration example of the event detecting section 52.

In FIG. 11, the event detecting section 52 includes a subtractor 430, a quantizer 440, a memory 451, and a controller 452. The subtractor 430 and the quantizer 440 correspond to the subtraction section 83 and the quantization section 84, respectively.

Note that, in FIG. 11, the event detecting section 52 further includes blocks corresponding to the current-voltage converting section 81 and the buffer 82, but the illustrations of the blocks are omitted in FIG. 11.

The subtractor 430 includes a capacitor 431, an operational amplifier 432, a capacitor 433, and a switch 434. The capacitor 431, the operational amplifier 432, the capacitor 433, and the switch 434 correspond to the capacitor 101, the operational amplifier 102, the capacitor 103, and the switch 104, respectively.

The quantizer 440 includes a comparator 441. The comparator 441 corresponds to the comparator 111.

The comparator 441 compares a voltage signal (difference signal) from the subtractor 430 with the predetermined threshold voltage Vth applied to the inverting input terminal (−). The comparator 441 outputs a signal indicating the comparison result, as a detection signal (quantized value).

The voltage signal from the subtractor 430 may be input to the input terminal (−) of the comparator 441, and the predetermined threshold voltage Vth may be input to the input terminal (+) of the comparator 441.

The controller 452 supplies the predetermined threshold voltage Vth applied to the inverting input terminal (−) of the comparator 441. The threshold voltage Vth which is supplied may be changed in a time-division manner. For example, the controller 452 supplies a threshold voltage Vth1 corresponding to ON events (for example, positive changes in photocurrent) and a threshold voltage Vth2 corresponding to OFF events (for example, negative changes in photocurrent) at different timings to allow the single comparator to detect a plurality of types of address events (events).

The memory 451 accumulates output from the comparator 441 on the basis of Sample signals supplied from the controller 452. The memory 451 may be a sampling circuit, such as a switch, plastic, or capacitor, or a digital memory circuit, such as a latch or flip-flop. For example, the memory 451 may hold, in a period in which the threshold voltage Vth2 corresponding to OFF events is supplied to the inverting input terminal (−) of the comparator 441, the result of comparison by the comparator 441 using the threshold voltage Vth1 corresponding to ON events.

Note that, the memory 451 may be omitted, may be provided inside the pixel (pixel block 41), or may be provided outside the pixel.

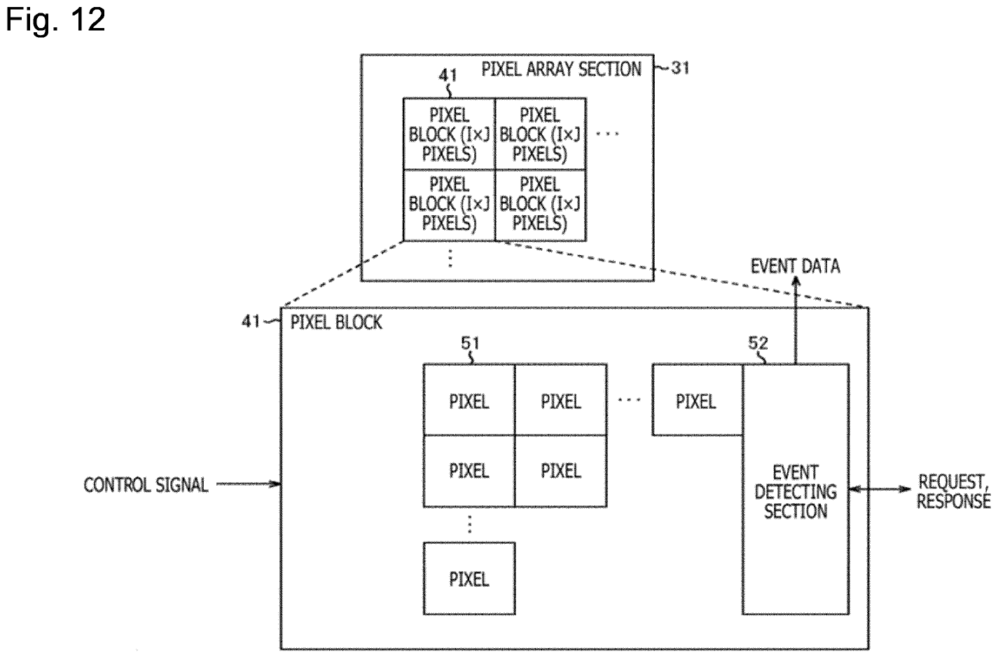

FIG. 12 is a block diagram illustrating another configuration example of the pixel array section 31 of FIG. 2.

Note that, in FIG. 12, parts corresponding to those in the case of FIG. 3 are denoted by the same reference signs, and the description thereof is omitted as appropriate below.

In FIG. 12, the pixel array section 31 includes the plurality of pixel blocks 41. The pixel block 41 includes the I×J pixels 51 that are one or more pixels and the event detecting section 52.

Thus, the pixel array section 31 of FIG. 12 is similar to the case of FIG. 3 in that the pixel array section 31 includes the plurality of pixel blocks 41 and that the pixel block 41 includes one or more pixels 51 and the event detecting section 52. However, the pixel array section 31 of FIG. 12 is different from the case of FIG. 3 in that the pixel block 41 does not include the pixel signal generating section 53.

As described above, in the pixel array section 31 of FIG. 12, the pixel block 41 does not include the pixel signal generating section 53, so that the sensor section 21 (FIG. 2) can be formed without the AD conversion section 34. As further described above, the pixel signal generating section 53 and pixels 51 feeding into it may be placed on a different part of the die 11 or even on another sensor chip.

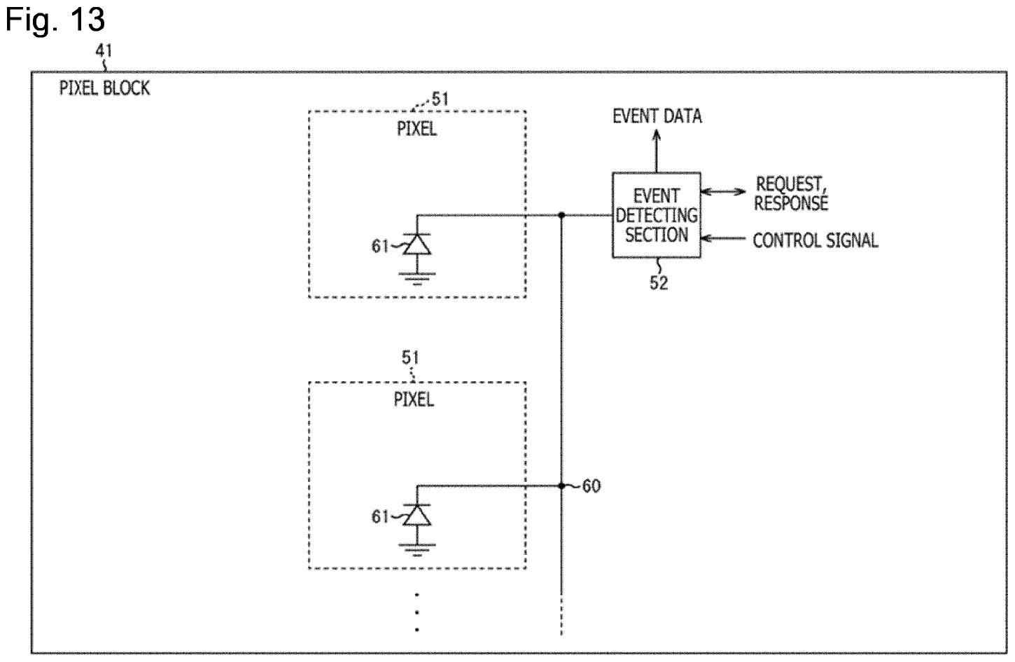

FIG. 13 is a circuit diagram illustrating a configuration example of the pixel block 41 of FIG. 12.

As described with reference to FIG. 12, the pixel block 41 includes the pixels 51 and the event detecting section 52, but does not include the pixel signal generating section 53.

In this case, the pixel 51 can only include the photoelectric conversion element 61 without the transfer transistors 62 and 63.

Note that, in the case where the pixel 51 has the configuration illustrated in FIG. 13, the event detecting section 52 can output a voltage corresponding to a photocurrent from the pixel 51, as a pixel signal.

Above, the sensor device 10 was described to be an asynchronous imaging device configured to read out events by the asynchronous readout system. However, the event readout system is not limited to the asynchronous readout system and may be the synchronous readout system. An imaging device to which the synchronous readout system is applied is a scan type imaging device that is the same as a general imaging device configured to perform imaging at a predetermined frame rate. Further, the event data detection may be performed asynchronously, while the pixel signal generation may be performed synchronously.

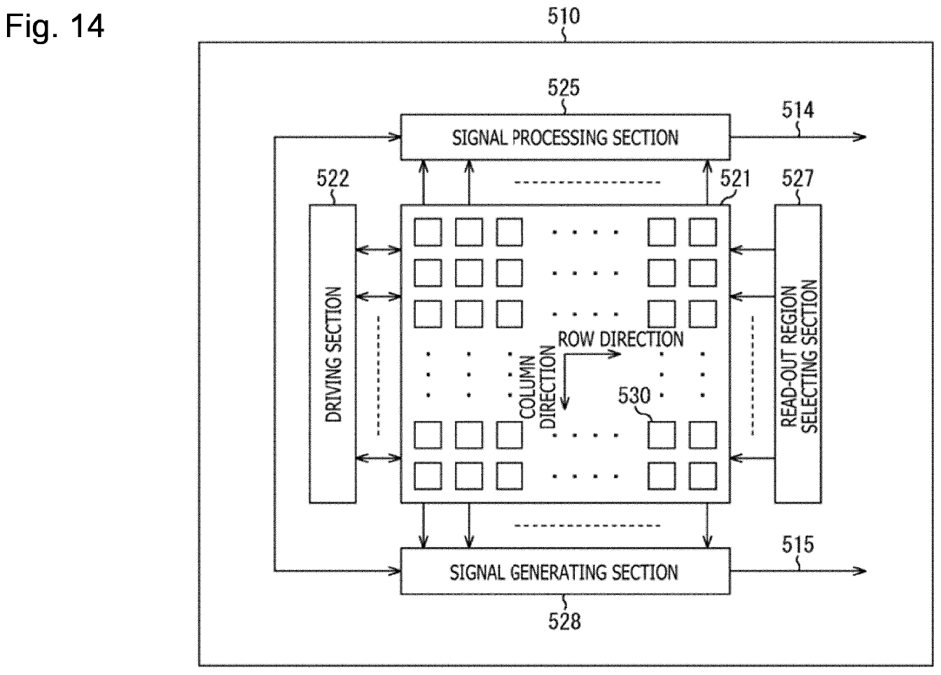

FIG. 14 is a block diagram illustrating a configuration example of a scan type imaging device.

As illustrated in FIG. 14, an imaging device 510 includes a pixel array section 521, a driving section 522, a signal processing section 525, a read-out region selecting section 527, and a signal generating section 528.

The pixel array section 521 includes a plurality of pixels 530. The plurality of pixels 530 each output an output signal in response to a selection signal from the read-out region selecting section 527. The plurality of pixels 530 can each include an in-pixel quantizer as illustrated in FIG. 11, for example. The plurality of pixels 530 output output signals corresponding to the amounts of change in light intensity. The plurality of pixels 530 may be two-dimensionally disposed in a matrix as illustrated in FIG. 14.

The driving section 522 drives the plurality of pixels 530, so that the pixels 530 output pixel signals generated in the pixels 530 to the signal processing section 525 through an output line 514. Note that, the driving section 522 and the signal processing section 525 are circuit sections for acquiring grayscale information. Thus, in a case where only event information (event data) is acquired, the driving section 522 and the signal processing section 525 may be omitted.

The read-out region selecting section 527 selects some of the plurality of pixels 530 included in the pixel array section 521. For example, the read-out region selecting section 527 selects one or a plurality of rows included in the two-dimensional matrix structure corresponding to the pixel array section 521. The read-out region selecting section 527 sequentially selects one or a plurality of rows on the basis of a cycle set in advance. Further, the read-out region selecting section 527 may determine a selection region on the basis of requests from the pixels 530 in the pixel array section 521.

The signal generating section 528 generates, on the basis of output signals of the pixels 530 selected by the read-out region selecting section 527, event signals corresponding to active pixels in which events have been detected of the selected pixels 530. The events mean an event that the intensity of light changes. The active pixels mean the pixel 530 in which the amount of change in light intensity corresponding to an output signal exceeds or falls below a threshold set in advance. For example, the signal generating section 528 compares output signals from the pixels 530 with a reference signal, and detects, as an active pixel, a pixel that outputs an output signal larger or smaller than the reference signal. The signal generating section 528 generates an event signal (event data) corresponding to the active pixel.

The signal generating section 528 can include, for example, a column selecting circuit configured to arbitrate signals input to the signal generating section 528. Further, the signal generating section 528 can output not only information regarding active pixels in which events have been detected, but also information regarding non-active pixels in which no event has been detected, i.e. it can operate as a conventional synchronous image sensor that generates a series of consecutive image frames.

The signal generating section 528 outputs, through an output line 515, address information and timestamp information (for example, (X, Y, T)) regarding the active pixels in which the events have been detected. However, the data that is output from the signal generating section 528 may not only be the address information and the timestamp information, but also information in a frame format (for example, (0, 0, 1, 0, . . . )).

In the above description a sensor device 10 has been described in which event data generation and pixel signal generation may depend on each other or may be independent of each other. Moreover, pixels 51 may be shared between event detection circuitry and pixel signal generating circuitry either by respective circuitry or by time multiplexing. But pixels 51 may also be divided such that there are event detection pixels and pixel signal generating pixels. These pixels 51 may be interleaved in the same pixel array or may be part of different pixel arrays on the same die or even be arranged on different dies.

In all these configurations event detection circuitry operates on a first subset of pixels 51 and is configured to detect as event data intensity changes above a predetermined threshold of the light received by each of the first subset of the pixels 51, and pixel signal generating circuitry operates on a second subset of pixels 51 and is configured to generate a pixel signal indicating intensity values of the received light for each pixel of the second subset of the pixels 51. Here, at least a part of the pixels 51 may belong to the first subset of pixels 51 and the second subset of pixels 51, i.e. it is a shared pixel 51 or a pixel 51 whose output is distributed in a time multiplexed manner. But the pixels 51 in the first subset of pixels 51 may also be different from pixels 51 in the second subset of pixels 51, i.e. the sensor device 10 may comprise divided pixels 51 for event detection and intensity frame generation.

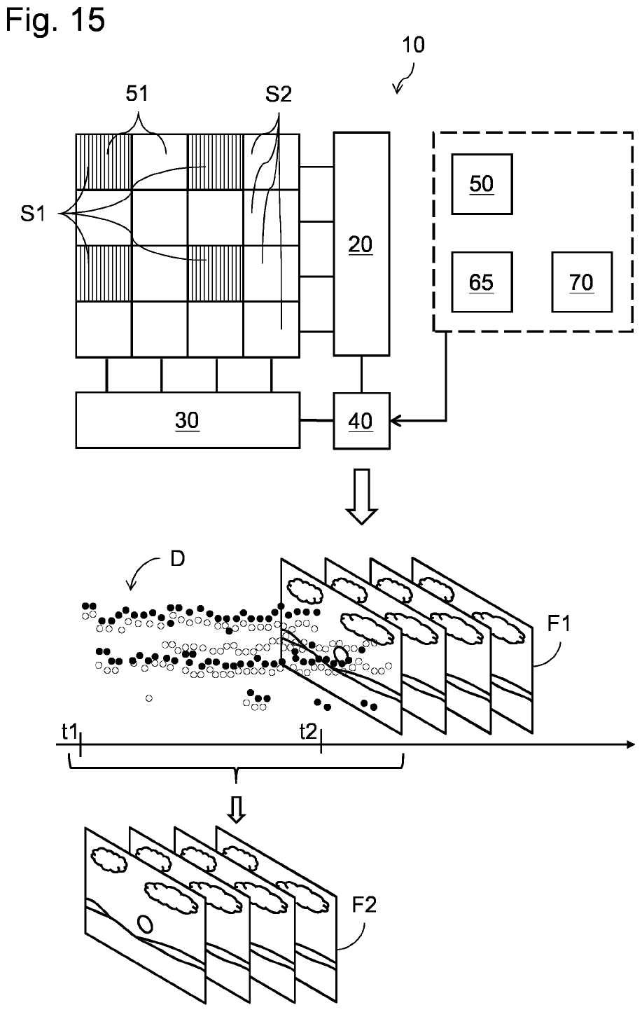

FIG. 15 shows schematically an according exemplary implementation of a sensor device 10. As stated above, the sensor device 10 comprises a plurality of pixels 51 that are each configured to receive light and perform photoelectric conversion to generate an electrical signal. Here, the pixels 51 might be arranged in pixel blocks 41 as described with respect to FIG. 3. For the ease of description it is assumed in the following without limitation that there is only one pixel 51 per pixel block 41, i.e. that pixels 51 and pixel blocks 41 refer to the same structural elements. However, the following description could be easily generalized by understanding any reference to a pixel 51 as a reference to a pixel block 41 comprising several pixels 51.

The sensor device 10 comprises event detection circuitry 20 that is configured to detect as event data D intensity changes above a predetermined threshold of the light received by each of a first subset S1 of the pixels 51. The event detection circuitry 20 is basically constituted by the event detecting sections 52 as described above that are capable to receive the photocurrent of the pixels 51 and to detect events due to intensity changes of the received light that are larger than predetermined (but potentially dynamically adjustable) event thresholds. Although the event detection circuitry 20 has been depicted in FIG. 15 as a block adjacent to the pixels 51 this has to be understood as merely symbolic. As discussed above, the event detecting sections 52 of the event detection circuitry 20 may be arranged close or next to the pixels 51. However, the event detecting sections 52 could also be grouped together in a dedicated area on the sensor chip. In particular, the event detection circuitry 20 could be arranged on a different wafer/die than the pixels 51 and be vertically connected with the pixels 51.

The pixels 51 comprise the first subset St. In FIG. 15 the pixels 51 of the first subset S1 are indicated by vertical hatching. These pixels 51 are connected to the event detection circuitry 20, e.g. as described above, and allow event detection on the light received by them.

The pixels 51 further comprise a second subset S2 that is formed in FIG. 15 by the unhatched pixels 51. The pixels 51 of the second subset S2 are used to generate full intensity information, i.e. to generate data representing the intensity of the light received by the pixels 51. Here, it is understood that appropriate color filters may be provided to each of the pixels 51 of the second subset S2 to allow generation of a color image. Color filters may also be provided to the pixels 51 of the first subset S1

The sensor device 10 comprises pixel signal generating circuitry 30 that is configured to generate a pixel signal indicating intensity values of the received light for each pixel 51 of the second subset S2 of the pixels 51. For example, the pixel signal generating circuitry 30 may be constituted by the pixel signal generating sections 53 as described above that can produce pixel signals indicating the received light intensity in an asynchronous (event triggered) or conventional, synchronous manner. In particular, the pixels 51 of the second subset S2 may operate according to the known principles of an active pixels sensor, APS.

Just as the event detection circuitry 20 also the pixel signal generating circuitry 30 may be formed either in a distributed manner, where e.g. one pixel signal generating section 53 is arranged next to or close to one pixel 51 of the second subset S2, or in a dedicated region of the sensor chip. The pixel signal generating circuitry 30 may also be considered to include all control, reset, and/or selection lines and the like that are necessary to operate the sensor device 10 as an APS that is capable to generate a consecutive stream of pixel signals indicating the intensity of the received light over a given time period.

The sensor device 10 comprises further a control unit 40 that is configured to start detection of event data D at a first point in time t1 and to start generation of pixel signals at a second point in time t2, wherein the first point in time t1 is earlier than the second point in time C. That is, during the time period between t1 and t2 only event data D are generated, but no pixel signals indicating the intensity of the received light.

Here, the control unit 40 may be any arrangement of circuitry that is capable to carry out the functions described above. For example, the control unit 40 may be constituted by a processor. The control unit 40 may be part of the pixel section of the sensor device 10 and may be placed on the same die(s) as the other components of the sensor device 10. But the control unit 10 may also be arranged separately, e.g. on a separate die. The functions of the control unit 10 may be fully implemented in hardware, in software or may be implemented as a mixture of hardware and software functions.

The control unit 40 is further configured to reconstruct intensity values for the second subset S2 of pixels 51 for a time period between the first point in time t1 and the second point in time t2 by using the pixel signals generated after the second point in time t2 and the event data D detected before the second point in time C. The control unit 40 uses therefore the intensity difference information that is present in the event data D to reconstruct, e.g. by integration, backwards in time intensity data for the pixels 51 of the second subset S2, such as to generate data that would have been present, if the generation of pixel signals by the pixels of the second subset D2 had started before the second point in time C.

This is illustrated in the lower part of FIG. 15. Here, event detection starts at time t1, producing a stream of event data D that is spatially distributed over the plurality of pixels 51 of the first subset S1. For example, as shown in FIG. 15 by black and white circles events of negative and positive polarity can be detected. At t2 capturing of a stream of intensity data with the second subset S2 of pixels starts, which is directed to the same scene as the one that was observed during event data generation. As illustrated in FIG. 15 the stream of intensity data might form a series of consecutive image frames F1, i.e. it might be a conventional video stream. However, the pixels of the second subset S2 need not necessarily be arranged adjacent to each other, but may also be sparsely distributed. In this case no full frames will be produced, but point shaped or patch-like image sections. Further, the intensity data may also be produced asynchronously, e.g. by being event triggered as described above.

Using the pixel signals carrying intensity information that were generated after the time t2 it is possible to produce corresponding intensity information for previous points in time by referring to the event data D. In fact, since the event data D carry information indicating at what time the intensity change has traversed the event threshold, it is in principle possible to track the intensity change of each pixel 51 of the second subset S2, if corresponding pixels 51 of the first subset S1 are present that observed the same part of the captured scene.

In this manner, the first intensity information obtained after the time t2 can be extrapolated backwards in time. As illustrated in FIG. 15, it is e.g. possible to supplement a series of intensity frames F1 captured after the time t2 with a series of preceding frames F2. The preceding intensity information may in principle reach back to the time t1 at which event detection started. The reconstructed time period may have a fixed length, e.g. between 1 to 5 seconds, or may be freely adjustable by a user of the sensor device 10.

Thus, it is possible to recover intensity information, e.g. in the form of the video frames F2, that precede the start of capturing of intensity information, e.g. via video frame capturing, through reconstruction. As described above, the reconstruction is possible due to the event data coming from the pixels 51 of the first subset S1, which are recorded preferably continuously at least between the first point in time t1 and the second point in time 2.

Since the event-based data are used together with the subsequent actually recorded intensity information to reconstruct backwards in time the missing intensity information, the reconstruction will have a more realistic and continuous appearance as compared to a situation where intensity information is reconstructed solely from event data, i.e. without reference to pixels signals from the second subset S2 of pixels 51.

Generation of event data is intrinsically less power consuming than generation of intensity information, e.g. since less pixels 51 will operate per instance of time. This effect can be strengthened if one uses less pixels 51 for event detection than for capturing of intensity information. Thus, in principle the event detection circuitry 20 can run continuously to allow backward reconstruction of intensity information always then, when capturing of, preferable frame based, intensity information is triggered. Thus, it can be avoided in a power saving manner that instances of time are missing at the beginning of a video, e.g. since a user was not able to trigger video capturing quick enough.

Here, it is in principle possible that the event detection is performed all the time the sensor device 10 is on, i.e. that the first point in time t1 is the time at which the sensor device 10 is switched on.

Alternatively, to reduce the energy consumption the event detection may be switched on based on a certain trigger, i.e. the first point in time t1 may also be a time at which the sensor device 10 senses a predetermined condition. To this end, the sensor device 10 may comprise or be connected to a variety of sensors measuring e.g. sound, temperature, humidity, movement of the sensor device, and the like. Based on the measurements of these sensors the control unit 40 decides whether or not to start event detection.

For example, as indicated in FIG. 15 by the dashed box the sensor device 10 may comprise further components, comprising e.g. an accelerometer unit 50 for detecting accelerations of the sensor device 10, wherein the first point in time t1 is a time at which a predetermined acceleration pattern has been detected by the accelerometer unit 50. In particular, any motion pattern that is typically performed with the sensor device 10 before capturing of a video is started can be used to trigger start of event detection.

For example, it can be sensed that the sensor device 10 (or the electronic equipment comprising it) is taken out of a storage position, like lying in a pocket, a bag, hanging on a neck strap or the like, and put in a steady position to focus on the scene of interest. Event detection can then start once the sensor device 10 is in a steady position long enough even if no trigger for starting capturing of intensity information has been received by the sensor device 10. The accelerometer unit 50 may in addition or alternatively also be used to record movements of the sensor device 10 to allow the control unit 40 to filter out effects of such movements (e.g. hand-shake or the like) from the event data processing and pixel signal generation/frame generation.

The sensor device may also contain a brightness sensor 65 that recognizes a change of brightness and triggers event detection according to such a change. The brightness sensor 65 may also be replaced or realized by one or a small group of the pixels 51 that provide intensity information to the control unit 40 and trigger event detection at a time at which a predetermined intensity is measured by this at least one of the pixels 51. Of course, the number of pixels 51 involved in this kind of brightness detection needs to be sufficiently small in order to keep the energy consumption low, e.g. in the order of 1 to 10 pixels.

Additionally or alternatively, the control unit 40 may be capable to recognize that a specific program run on the sensor device 10 (or electronic equipment comprising the sensor device 10) is opened that is used to control image capturing. Once the program is opened event detection is started, even though no image capturing instruction has been received from a user yet. For example, once the camera app on a smartphone is opened, the event detection may be started by the control unit 40.

The sensor device 10 may additionally or alternatively further comprise an input unit 70 for receiving inputs of a user of the sensor device 10. The first point in time t1 and/or the second point in time t2 can be the time at which the user provides a predetermined input to the input unit 70. The input unit 70 can take any form conceivable for the interaction with a human user. For example, it can have the form of one or several mechanical buttons or the form of a touchpad or touch screen resembling such mechanical buttons. The input unit 70 may also be able to record sound, like e.g. the voice of a user or to recognize certain (hand) gestures of a user. The control unit 40 is then configured to recognize commands of the user received via the input unit 70 and to control the sensor device 10 accordingly. Most typically, a user will trigger video capturing directly by pressing a button or a specific region on a touch pad, by uttering a specific phrase or by showing a specific hand gesture. But also event detection may be triggered explicitly by a (differing) user command.

The control unit 40 may also be configured to end detection of event data, when a rate of event detection per time falls below a predetermined value. This is in particular beneficial in situations where the start of event detection is triggered automatically. In such a situation a user of the sensor device 10 may not be aware that event detection is running. If the user did not intend to capture intensity information and puts the sensor device 10 in a position in which no or only static intensity information is received, like e.g. into a pocket or a bag or in a fixed position on a table or the like, the event detection may be switched off to save energy, since it is not to be expected that intensity image capturing will start soon. This improves the energy saving potential, in particular if used together with an automatic start of event detection, since event detection will not be carried out when unnecessary.

As explained above event detection can provide information of net intensity differences between consecutive instances in time. Therefore, it is possible to integrate an event stream back in time. In principle, it is even possible to reconstruct video sequences from an event data stream without referring to absolute intensity information. Here, one relies on regularities of natural images, i.e. on the fact that it is known how a true image looks in terms of possible intensity gradients, possible boundary lines, etc. However, in this process coarse image features are usually lost due to additive invariances of temporal difference operators (i.e. event data streams are insensitive to temporally-constant intensity variations).

This deficiency is mitigated by using the pixel signals that carry absolute intensity information and that were recorded after the second point in time t2 as boundary conditions. These boundary conditions provide also more natural images since they provide image style information. Moreover, the spatial image resolution can be improved, if event detection is carried out with a low spatial resolution to reduce energy consumption.

From a methodological point of view, the absolute intensity information that is used as boundary conditions provide convex constraints for event data stream based reconstruction applied in the framework of compressed sensing or learned neural networks. From a mathematical point of view the generic reconstruction problem can be formulated to be:

Find the sequence of reconstructed pixel signals Xt such that a model of corresponding event generation, EVSmodel, that is applied to Xt corresponds to the actually detected event data Et:

EVSmodel(Xt)≈Et.

When boundary conditions in the form of absolute intensity values are incorporated into the problem the above can be reformulated as follows:

EVSmodel(Xt)≈Et and X0=Y0, with Y0 representing the boundary condition.

This highlights the fact, that the data from normal frame-based cameras can be easily incorporated as additional or supplementary information into existing reconstruction algorithms that are solely based on event data.

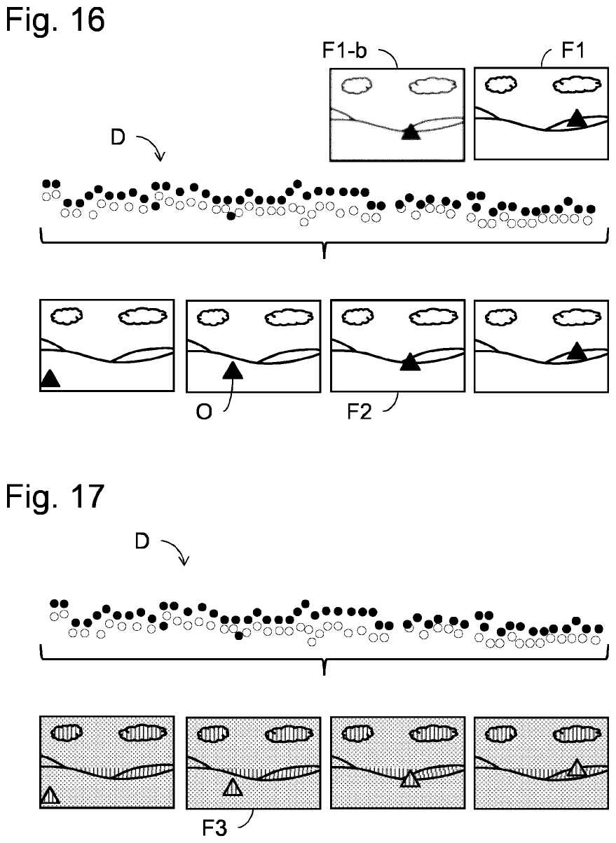

FIG. 16 shows a schematic illustration of such a reconstruction of intensity values by starting from pixel signals generated after the second point in time t2 and by interpolating these pixels signals backwards in time based on the event data D detected before the second point in time t2, which is compared in FIG. 17 schematically with the situation of pure event data based reconstruction.

FIG. 16 shows the first to frames F1-b and F1 of a video sequence. Here, the first frame F1-b is blurred due to excessive motion during image capturing or might show under- or over-exposure. Further, FIG. 16 shows the stream of event data D, capturing of which has been started before capturing of the first frame F1-b. Here, the first frame F1-b is discarded by the control unit 40 as starting point for the image reconstruction due to excessive motion blur. As boundary condition for image reconstruction the first sufficiently sharp frame F1, i.e. the first frame F1 with a degree of motion blur below a given limit, is used. The intensity differences encoded in the detected events are then used to reconstruct frames F2 backwards in time. Here, also information from the blurred image F1-b can be used to check the interpolation result for these frames, while on the other hand the interpolation will remove the effects of motion blur due to the improved dynamic range and the reduced latency of the event generation. In this manner it is possible to generate a series of frames F2 showing e.g. the movement of an object of interest O in the scene previous to the actual trigger of video capturing.

By adopting true color and contrast information from the boundary condition frame F1 the reconstructed frames F2 will share natural color and contrast and will therefore have a maximal similarity with actually captured image frames.

This improvement of the reconstruction result is schematically illustrated by the comparison example of FIG. 17. Here, it is shown that frames F3 reconstructed solely from an event data stream will contain in principle all details of the captured scene, however, without giving the correct contrast or the correct color of the scene. With respect to purely event based reconstruction algorithms and regarding the quality of the reconstruction it is therefore advantageous, if one takes absolute intensity information into account, and does not omit this information to save space on the sensor chip or to reduce the energy consumption even further.

The control unit 40 may also be configured to reconstruct intensity values based on an artificial intelligence model that receives the pixel signals generated after the second point in time 2 and the event data detected before the second point in time t2 as input and provides the reconstructed intensity values as output. Thus, according to this implementation the control unit 40 will not carry out an explicit extrapolation starting from the intensity information obtained after the second point in time C. Instead, the control unit 40 will rely on an artificial intelligence model that will “know” which reconstructed data to produce once it is fed with a given set of captured intensity values and event data.

This can be achieved by appropriate training of the artificial intelligence model. For example, one can use a neuronal network NN to create intensity information for the time segment [0, T_{END}]. Here, NN has as input event data EVS over the entire time segment and intensity information I_{cap} that was captured after the second point in time t2, where 0<t2<T_{END}. The network needs then to be trained by tuning its weights such that its output resembles the actually captured intensity information I_{cap}:

I_{cap}[0, T_{END}]=NN(EVS[0, T_{END}], I_{cap}[t2, T_{END}])

Here, the captured intensity information I_{cap} might either be truly captured or consist of rendered 2D images imposed on a moving 3D plane. From this captured intensity information the event data EVS can be generated by an event data simulator. In this manner the inputs EVS[0, T_{END}] and I_{cap}[t2, T_{END}] as well as the reference I_{cap}[0, T_{END}] can be produced and the weights of the network NN can be tuned based on various according training sets such as to satisfy the above relation as good as possible, e.g. in terms of a perceptual image metric as for example an Learned Perceptual Image Patch Similarity (LPIPS) metric.

Intuitively this means that given a complete event data stream and a partial intensity value stream, the complete intensity value stream should be recovered. Training can be finished when the generated intensity value stream matches the known intensity value stream to a sufficient degree.

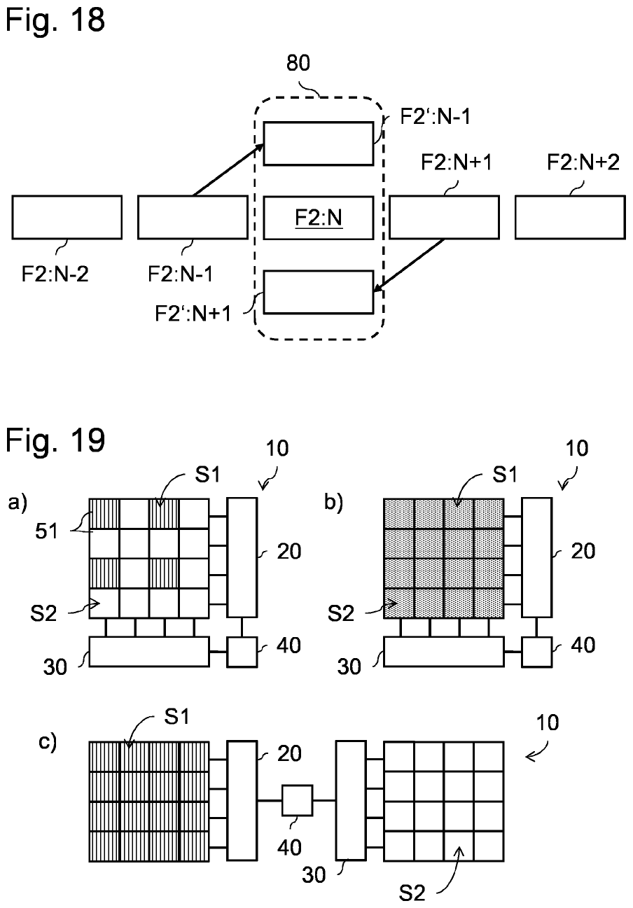

Further, in order to achieve optimal stitchless combination of the reconstructed intensity information and the captured intensity information, motion fields from the event data stream to transfer information from actual intensity value recording may be considered as well as perceptual style discrepancies between the event data and the actual intensity value streams. Here one may train a model-aware neural network that has a motion field estimation block 80 as illustrated in FIG. 18, while the perceptual style information may be transferred automatically, during neural network training.

FIG. 18 shows a series of five frames F2 centered around the N^{th} frame F2:N. Based on the preceding frame F2:N−1 and the following frame F2:N+1 warped frames F2′:N−1 and F2′:N+1 are created that are then fed into the motion field estimation block 80 to generate a motion compensated frame, e.g. via a regularization network that relies on natural image regularities.

In this manner a neuronal network can be provided that allows an automatic assignment of reconstructed intensity information to captured intensity information and an event data stream.

In the schematic illustration of the sensor device 10 given in FIG. 15, which is also shown in FIG. 19 a) the pixels 51 in the first subset S1 differ from the pixels 51 in the second subset S2. Thus, while the event detection circuitry 20 receives signals only from the first subset St in this example, the pixel signal generating unit 30 receives signals only from the second subset S2.

As shown in FIGS. 15 and 19 a) one implementation for such a division of pixels 51 is to arrange all pixels 51 in a single pixel array. Then, a specific number of pixels 51 can be designed for event detection, such as by providing circuitry as described above with respect to FIG. 13, for example for one pixel of a N×M pixel group, e.g. of a 2×2 pixel group as shown in FIGS. 15 and 19 a). These pixels 51 form then the first subset S1 of pixels 51. The remaining pixels 51 form the second subset S2 of pixels 51, and can be provided with conventional circuitry for a synchronous readout. Due to the sparse distribution of the pixels 51 of the first subset St a larger energy saving effect can be achieved for the periods where only event detection is active.

However, at least a part of the pixels 51 may belong to the first subset of pixels 51 as well as to the second subset of pixels 51. For example, all pixels 51 of a pixel array may function as pixels 51 of the first subset S1 and the second subset S2 as schematically illustrated in FIG. 19 b). The pixels 51 may then be connected to the event detection circuitry 20 and the pixel signal circuitry 30 e.g. as described above with respect to FIG. 4, i.e. each pixel 51 can be selectively chosen to transfer its photocurrent to the event detection circuitry 20 or the pixel signal generation circuitry 30, e.g. in a time multiplexed manner. This shared pixel architecture allows to have the same spatial resolution for event detection and intensity information generation, which leads to improved quality of the reconstructed intensity information.

In the above description it was assumed that pixels 51 of both pixel subsets S1, S2 were part of the same pixel array. However, as schematically illustrated in FIG. 19 c) it is also conceivable that two different pixel arrays are used that each contain only pixels 51 of one pixel subset, either on different parts of a single die or even on different sensor chips. As long as both pixel arrays observe the same scene it will nevertheless be possible to reconstruct intensity information for the pixels 51 of the second subset S2 based on the events detected by the pixels 51 of the first subset S1.

In general, any geometrical arrangement of pixels 51 with shared or divided functionality will be sufficient as long as event data and intensity information of the same scene can be obtained. If there is a mismatch in spatial resolution or if it is not possible to map the solid angles observed by pixels 51 in different subsets in a one to one manner, this will be solvable in principle by using interpolation techniques to adapt/align the two different data sets. Further, if artificial intelligence models are used, such differences are irrelevant as long as the training data show the same differences.

Further, in the above description it was assumed that pixel signals of the second subset of pixels 51 form a consecutive series of image/intensity frames F1, and that the reconstructed intensity values form image/intensity frames F2 that precede the consecutive series of image/intensity frames F1. It is to be understood that this served only the ease of description. In principle it will be possible to use any set of intensity information generated after the second point in time t2 together with the event data stream to reconstruct according intensity information for the time before the second point in time t2 during which event detection was already active.

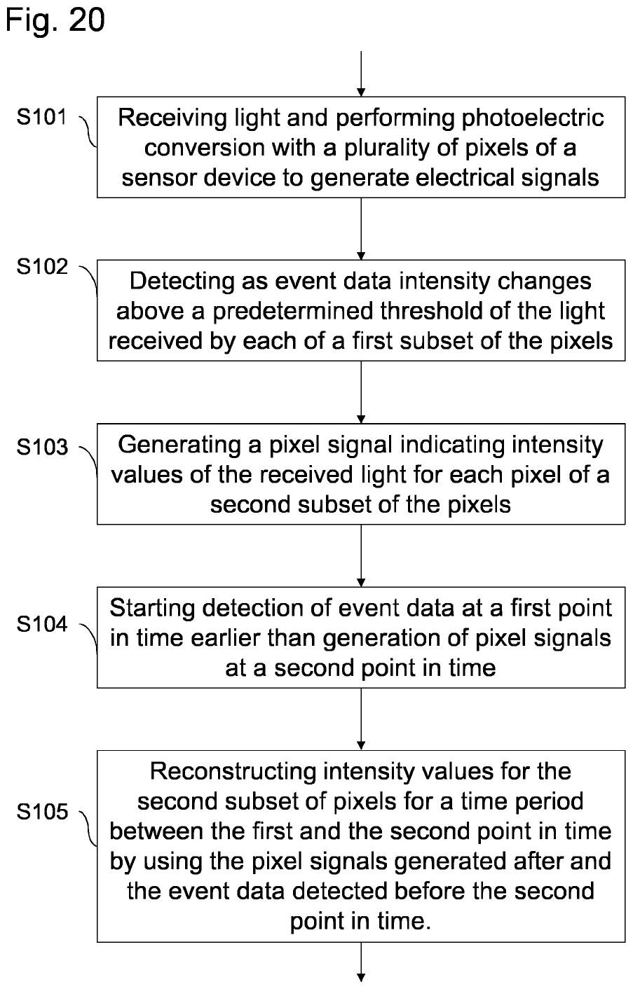

Above various implementations of the basic idea to reconstruct temporally preceding intensity information based on event data and temporally subsequently captured intensity information have been discussed. The basic method underlying all these implementations is summarized below with respect to FIG. 20.

Here, at S101 light is received and photoelectric conversion is performed with a plurality of pixels 51 of a sensor device 10 as described above to generate an electrical signal.

At S102 intensity changes above a predetermined threshold of the light received by each of a first subset of the pixels 51 are detected as event data.

At S103 pixel signals are generated that indicate intensity values of the received light for each pixel 51 of a second subset of the pixels 51.

At S104 detection of event data is started at a first point in time t1 earlier than generation of pixel signals at a second point in time t2.

At S105 intensity values are reconstructed for the second subset of pixels 51 for a time period between the first point in time t1 and the second point in time t2 by using the pixel signals generated after the second point in time t2 and the event data detected before the second point in time t2.

In this manner it is possible to supplement intensity information obtained after a predetermined trigger with reconstructed intensity information that proceeds the trigger time.

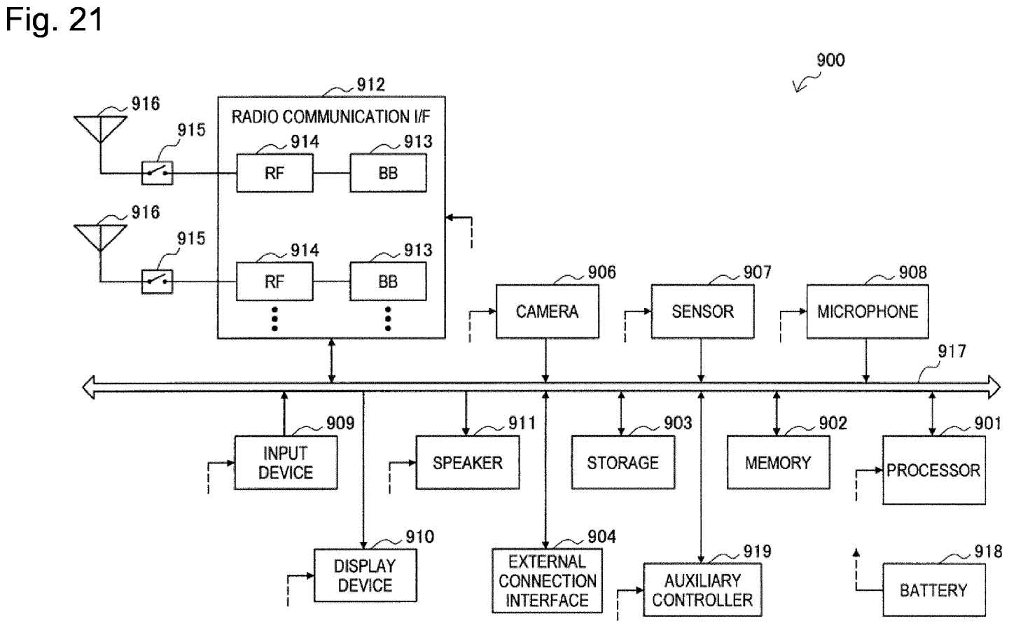

FIG. 21 is a block diagram illustrating an example of a schematic configuration of a smartphone 900 that may constitute or comprise a sensor device 10 as described above. The smartphone 900 is equipped with a processor 901, memory 902, storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be a CPU or system-on-a-chip (SoC), for example, and controls functions in the application layer and other layers of the smartphone 900. The memory 902 includes RAM and ROM, and stores programs executed by the processor 901 as well as data. The storage 903 may include a storage medium such as semiconductor memory or a hard disk. The external connection interface 904 is an interface for connecting an externally attached device, such as a memory card or Universal Serial Bus (USB) device, to the smartphone 900. The processor may function as control unit 40.

The camera 906 includes an image sensor as described above. The sensor 907 may include a sensor group such as a positioning sensor, a gyro sensor, a geomagnetic sensor, and an acceleration sensor, for example. The microphone 908 converts audio input into the smartphone 900 into an audio signal. The input device 909 includes devices such as a touch sensor that detects touches on a screen of the display device 910, a keypad, a keyboard, buttons, or switches, and receives operations or information input from a user. The display device 910 includes a screen such as a liquid crystal display (LCD) or an organic light-emitting diode (OLED) display, and displays an output image of the smartphone 900. The speaker 911 converts an audio signal output from the smartphone 900 into audio.

The radio communication interface 912 supports a cellular communication scheme such as LTE or LTE-Advanced, and executes radio communication. Typically, the radio communication interface 912 may include a BB processor 913, an RF circuit 914, and the like. The BB processor 913 may conduct processes such as encoding/decoding, modulation/demodulation, and multiplexing/demultiplexing, for example, and executes various signal processing for radio communication. Meanwhile, the RF circuit 914 may include components such as a mixer, a filter, and an amp, and transmits or receives a radio signal via an antenna 916. The radio communication interface 912 may also be a one-chip module integrating the BB processor 913 and the RF circuit 914. The radio communication interface 912 may also include multiple BB processors 913 and multiple RF circuits 91. Note that although FIG. 21 illustrates an example of the radio communication interface 912 including multiple BB processors 913 and multiple RF circuits 914, the radio communication interface 912 may also include a single BB processor 913 or a single RF circuit 914.

Furthermore, in addition to a cellular communication scheme, the radio communication interface 912 may also support other types of radio communication schemes such as a short-range wireless communication scheme, a near field wireless communication scheme, or a wireless local area network (LAN) scheme. In this case, a BB processor 913 and an RF circuit 914 may be included for each radio communication scheme.

Each antenna switch 915 switches the destination of an antenna 916 among multiple circuits included in the radio communication interface 912 (for example, circuits for different radio communication schemes).

Each antenna 916 includes a single or multiple antenna elements (for example, multiple antenna elements constituting a MIMO antenna), and is used by the radio communication interface 912 to transmit and receive radio signals. The smartphone 900 may also include multiple antennas 916 as illustrated in FIG. 21. Note that although FIG. 21 illustrates an example of the smartphone 900 including multiple antennas 916, the smartphone 900 may also include a single antenna 916.

Furthermore, the smartphone 900 may also be equipped with an antenna 916 for each radio communication scheme. In this case, the antenna switch 915 may be omitted from the configuration of the smartphone 900.

The bus 917 interconnects the processor 901, the memory 902, the storage 903, the external connection interface 904, the camera 906, the sensor 907, the microphone 908, the input device 909, the display device 910, the speaker 911, the radio communication interface 912, and the auxiliary controller 919. The battery 918 supplies electric power to the respective blocks of the smartphone 900 illustrated in FIG. 21 via power supply lines partially illustrated with dashed lines in the drawing. The auxiliary controller 919 causes minimal functions of the smartphone 900 to operate while in a sleep mode, for example.

Note that, the embodiments of the present technology are not limited to the above-mentioned embodiment, and various modifications can be made without departing from the gist of the present technology.

Further, the effects described herein are only exemplary and not limited, and other effects may be provided.

Note that, the present technology can also take the following configurations.

1. A sensor device comprising:
a plurality of pixels each configured to receive light and perform photoelectric conversion to generate an electrical signal;
event detection circuitry that is configured to detect as event data intensity changes above a predetermined threshold of the light received by each of a first subset of the pixels;
pixel signal generating circuitry that is configured to generate a pixel signal indicating intensity values of the received light for each pixel of a second subset of the pixels;
a control unit that is configured to start detection of event data at a first point in time earlier than generation of pixel signals at a second point in time, and to reconstruct intensity values for the second subset of pixels for a time period between the first point in time and the second point in time by using the pixel signals generated after the second point in time and the event data detected before the second point in time.

2. The sensor device according to 1, wherein
the first point in time is a time at which the sensor device is switched on.

3. The sensor device according to 1, wherein
the first point in time is a time at which the sensor device senses a predetermined condition.

4. The sensor device according to 3, further comprising
an accelerometer unit for detecting accelerations of the sensor device; and
the first point in time is a time at which a predetermined acceleration pattern has been detected by the accelerometer unit.

5. The sensor device according to 3 or 4, wherein
the first point in time is a time at which a predetermined intensity is measured by at least one of the pixels.

6. The sensor device according to any one of 1 to 5, further comprising
an input unit for receiving inputs of a user of the sensor device; wherein
the second point in time is a time at which the user provides a predetermined input to the input unit.

7. The sensor device according to any one of 1 to 6, wherein
the control unit is configured to end detection of event data, when a rate of event detection per time falls below a predetermined value.

8. The sensor device according to any one of 1 to 7, wherein
the control unit is configured to reconstruct the intensity values by starting from pixel signals generated after the second point in time and by interpolating these pixels signals backwards in time based on the event data detected before the second point in time.

9. The sensor device according to any one of 1 to 7, wherein
the control unit is configured to reconstruct the intensity values based on an artificial intelligence model that receives the pixel signals generated after the second point in time and the event data detected before the second point in time as input and provides the reconstructed intensity values as output.

10. The sensor device according to any one of 1 to 9, wherein
at least a part of the pixels belongs to the first subset of pixels and the second subset of pixels.

11. The sensor device according to any one of 1 to 9, wherein
pixels in the first subset of pixels are different from pixels in the second subset of pixels.

12. The sensor device according to any one of 1 to 11, wherein
pixel signals of the second subset of pixels form a consecutive series of image frames; and
the reconstructed intensity values form image frames that precede the consecutive series of image frames.

13. A method for operating a sensor device according to any one of 1 to 12, the method comprising:
receiving light and performing photoelectric conversion with a plurality of pixels of the sensor device to generate an electrical signal;
detecting as event data intensity changes above a predetermined threshold of the light received by each of a first subset of the pixels;
generating a pixel signal indicating intensity values of the received light for each pixel of a second subset of the pixels;
starting detection of event data at a first point in time earlier than generation of pixel signals at a second point in time; and
reconstructing intensity values for the second subset of pixels for a time period between the first point in time and the second point in time by using the pixel signals generated after the second point in time and the event data detected before the second point in time.

1. A sensor device comprising:
a plurality of pixels each configured to receive light and perform photoelectric conversion to generate an electrical signal;
event detection circuitry that is configured to detect as event data intensity changes above a predetermined threshold of the light received by each of a first subset of the pixels;
pixel signal generating circuitry that is configured to generate a pixel signal indicating intensity values of the received light for each pixel of a second subset of the pixels;
a control unit that is configured to start detection of event data at a first point in time earlier than generation of pixel signals at a second point in time, and to reconstruct intensity values for the second subset of pixels for a time period between the first point in time and the second point in time by using the pixel signals generated after the second point in time and the event data detected before the second point in time.

2. The sensor device according to claim 1, wherein
the first point in time is a time at which the sensor device is switched on.

3. The sensor device according to claim 1, wherein
the first point in time is a time at which the sensor device senses a predetermined condition.

4. The sensor device according to claim 3, further comprising
an accelerometer unit for detecting accelerations of the sensor device; and
the first point in time is a time at which a predetermined acceleration pattern has been detected by the accelerometer unit.

5. The sensor device according to claim 3, wherein
the first point in time is a time at which a predetermined intensity is measured by at least one of the pixels.

6. The sensor device according to claim 1, further comprising
an input unit for receiving inputs of a user of the sensor device; wherein
the second point in time is a time at which the user provides a predetermined input to the input unit.

7. The sensor device according to claim 1, wherein
the control unit is configured to end detection of event data, when a rate of event detection per time falls below a predetermined value.

8. The sensor device according to claim 1, wherein
the control unit is configured to reconstruct the intensity values by starting from pixel signals generated after the second point in time and by interpolating these pixels signals backwards in time based on the event data detected before the second point in time.

9. The sensor device according to claim 1, wherein
the control unit is configured to reconstruct the intensity values based on an artificial intelligence model that receives the pixel signals generated after the second point in time and the event data detected before the second point in time as input and provides the reconstructed intensity values as output.

10. The sensor device according to claim 1, wherein
at least a part of the pixels belongs to the first subset of pixels and the second subset of pixels.

11. The sensor device according to claim 1, wherein
pixels in the first subset of pixels are different from pixels in the second subset of pixels.

12. The sensor device according to claim 1, wherein
pixel signals of the second subset of pixels form a consecutive series of image frames; and
the reconstructed intensity values form image frames that precede the consecutive series of image frames.

13. A method for operating a sensor device, the method comprising:
receiving light and performing photoelectric conversion with a plurality of pixels of the sensor device to generate an electrical signal;
detecting as event data intensity changes above a predetermined threshold of the light received by each of a first subset of the pixels;
generating a pixel signal indicating intensity values of the received light for each pixel of a second subset of the pixels;
starting detection of event data at a first point in time earlier than generation of pixel signals at a second point in time; and
reconstructing intensity values for the second subset of pixels for a time period between the first point in time and the second point in time by using the pixel signals generated after the second point in time and the event data detected before the second point in time.
